(19) United States
(12) Patent Application Publication
(10) Pub. No.: US 2026/0206068 A1
(43) Pub. Date: Jul. 16, 2026

(54) EARLY SRS TRIGGERING

(71) Applicant: Samsung Electronics Co., Ltd., Suwon-si (KR)

(72) Inventors: Emad Nader Farag, Flanders, NJ (US); Anil Agiwal, McKinney, TX (US); Eko Onggosanusi, Coppell, TX (US)

(21) Appl. No.: 19/438,209

(22) Filed: Dec. 31, 2025

Related U.S. Application Data
(60) Provisional application No. 63/746,098, filed on Jan. 16, 2025.
(60) Provisional application No. 63/747,762, filed on Jan. 21, 2025.
(60) Provisional application No. 63/749,314, filed on Jan. 24, 2025.
(60) Provisional application No. 63/858,065, filed on Aug. 5, 2025.

(51) Int. Cl. H04W 74/0833; H04L 27/26; H04W 72/232

(52) U.S. Cl. CPC H04W 74/0833; H04L 27/261; H04W 72/232

(57) ABSTRACT

Apparatuses and methods for early sounding reference signal (SRS) triggering. A method performed by a user equipment includes receiving a system information block (SIB) and initiating a Type-1 random access (RA) procedure to transition from an idle state to a connected state. The SIB includes N groups of SRS resource sets for antenna switching. The N groups of SRS resource sets correspond to N antenna switching capabilities, respectively. The method further includes transmitting, in a message 3 (msg3) of the RA procedure, information indicating an antenna switching capability from the N antenna switching capabilities supported by the UE, receiving, in a message 4 (msg4) of the RA procedure, signaling that triggers transmission of an SRS resource set from the N groups of SRS resource sets, and transmitting SRS resources from the SRS resource set. The SRS resource set corresponds to the antenna switching capability.

### CROSS-REFERENCE TO RELATED AND CLAIM OF PRIORITY

The present application claims priority under 35 U.S.C. § 119 (e) to U.S. Provisional Patent Application No. 63/746,098 filed on Jan. 16, 2025; U.S. Provisional Patent Application No. 63/747,762 filed on Jan. 21, 2025; U.S. Provisional Patent Application No. 63/749,314 filed on Jan. 24, 2025; and U.S. Provisional Patent Application No. 63/858,065 filed on Aug. 5, 2025, which are hereby incorporated by reference in their entirety.

### TECHNICAL FIELD

The present disclosure relates generally to wireless communication systems and, more specifically, the present disclosure is related to early sounding reference signal (SRS) triggering.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a method and apparatus for early SRS triggering.

In one embodiment, a user equipment (UE) is provided. The UE includes a transceiver configured to receive a system information block (SIB). The SIB includes N groups of SRS resource sets for antenna switching. The N groups of SRS resource sets correspond to N antenna switching capabilities, respectively. The UE further includes a processor operably coupled to the transceiver. The processor is configured to initiate a Type-1 random access (RA) procedure to transition from an idle state to a connected state. The transceiver is further configured to transmit, in a message 3 (msg3) of the RA procedure, information indicating an antenna switching capability from the N antenna switching capabilities supported by the UE, receive, in a message 4 (msg4) of the RA procedure, signaling that triggers transmission of an SRS resource set from the N groups of SRS resource sets that corresponds to the antenna switching capability, and transmit SRS resources from the SRS resource set.

In another embodiment, a base station (BS) is provided. The BS includes a processor and a transceiver operably coupled to the processor. The transceiver is configured to transmit a SIB that includes N groups of SRS resource sets for antenna switching and that correspond to N antenna switching capabilities, respectively, receive a physical random access channel (PRACH) preamble from a UE for a Type-1 RA procedure to transition from an idle state to a connected state, receive, in msg3 of the RA procedure, information indicating an antenna switching capability from the N antenna switching capabilities supported by the UE, transmit, in msg4 of the RA procedure, signaling that triggers transmission, from the UE, of an SRS resource set from the N groups of SRS resource sets that corresponds to the antenna switching capability, and receive SRS resources from the SRS resource set.

In yet another embodiment, a method of operating a UE is provided. The method includes receiving a SIB and initiating a Type-1 RA procedure to transition from an idle state to a connected state. The SIB includes N groups of SRS resource sets for antenna switching. The N groups of SRS resource sets correspond to N antenna switching capabilities, respectively. The method further includes transmitting, in a msg3 of the RA procedure, information indicating an antenna switching capability from the N antenna switching capabilities supported by the UE, receiving, in a msg4 of the RA procedure, signaling that triggers transmission of an SRS resource set from the N groups of SRS resource sets, and transmitting SRS resources from the SRS resource set. The SRS resource set corresponds to the antenna switching capability.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5A illustrates an example beam operation in a wireless communication system according to embodiments of the present disclosure;

FIG. 5B illustrates an example multi-beam operation in a wireless communication system according to embodiments of the present disclosure;

FIG. 6 illustrates an example of a transmitter structure for beamforming according to embodiments of the present disclosure;

FIG. 7 illustrates an SSB according to embodiments of the present disclosure;

FIG. 8 illustrates a type-1 random access procedure also known as four-step random access procedure (4-step RACH) according to embodiments of the present disclosure;

FIG. 9 illustrates a type-2 random access procedure, also known as 2-step random access procedure (2-step RACH) according to embodiments of the present disclosure;

FIGA. 10A-10C illustrate examples of random access response (RAR) media access control (MAC) control elements (CEs) according to embodiments of the present disclosure;

FIG. 11 illustrates an example procedure for SRS triggering according to embodiments of the present disclosure;

FIG. 12 illustrates an example of SRS instances in a band according to embodiments of the present disclosure;

FIGS. 13A-E illustrate examples of fields related to a UE ID and SRS resource ID (and/or SRS resource set ID) in a message triggering SRS transmission according to embodiments of the present disclosure;

FIGS. 14A-C illustrate examples of fields in a message triggering SRS transmission according to embodiments of the present disclosure;

FIG. 15A illustrates an example of an SRS configuration according to embodiments of the present disclosure;

FIGS. 15B-C illustrate examples of SRS transmissions according to embodiments of the present disclosure;

FIG. 16 illustrates an example procedure for early SRS triggering for idle mode according to embodiments of the present disclosure;

FIG. 17 illustrates an example procedure for early SRS triggering for an inactive mode according to embodiments of the present disclosure; and

FIG. 18 illustrates an example method performed by a UE in a wireless communication system according to embodiments of the present disclosure.

### DETAILED DESCRIPTION

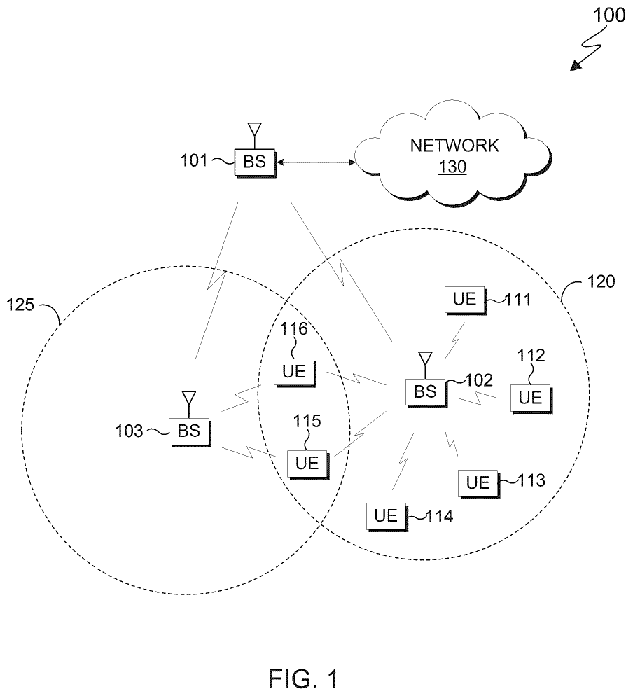

FIGS. 1-18 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.1.0, “Physical channels and modulation” (herein, “REF 1”); 3GPP TS 38.212 v18.1.0, “NR; Multiplexing and Channel coding” (herein, “REF 2”); 3GPP TS 38.213 v18.1.0, “NR; Physical Layer Procedures for Control” (herein, “REF 3”); 3GPP TS 38.214 v18.1.0, “NR; Physical Layer Procedures for Data” (herein, “REF 4”); 3GPP TS 38.321 v18.0.0, “NR; Medium Access Control (MAC) protocol specification” (herein, “REF 5”); 3GPP TS 38.331 v18.0.0, and “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for early SRS triggering. In certain embodiments, one or more of the BS 101-103 include circuitry, programing, or a combination thereof to support early SRS triggering.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

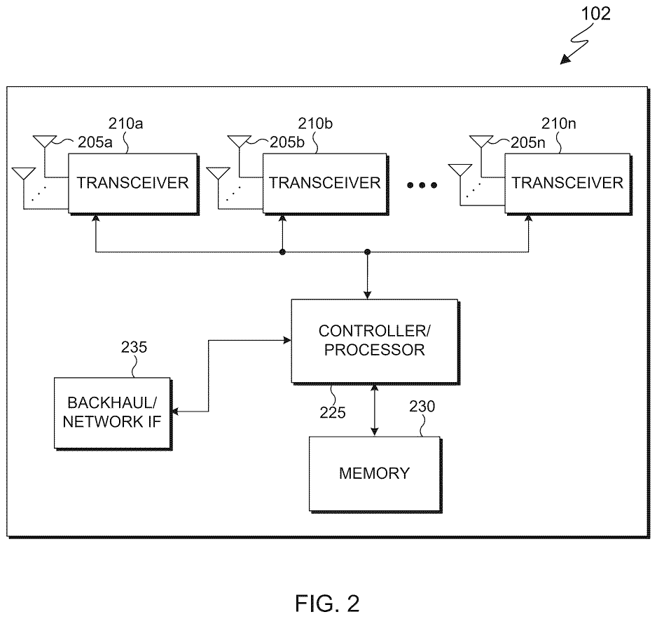

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of UL channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for early SRS triggering. Any of a wide variety of other functions could be supported in the BS 102 by the controller/processor 225.

The controller/processor 225 is also capable of executing programs and other processes resident in the memory 230, such as processes to support early SRS triggering. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

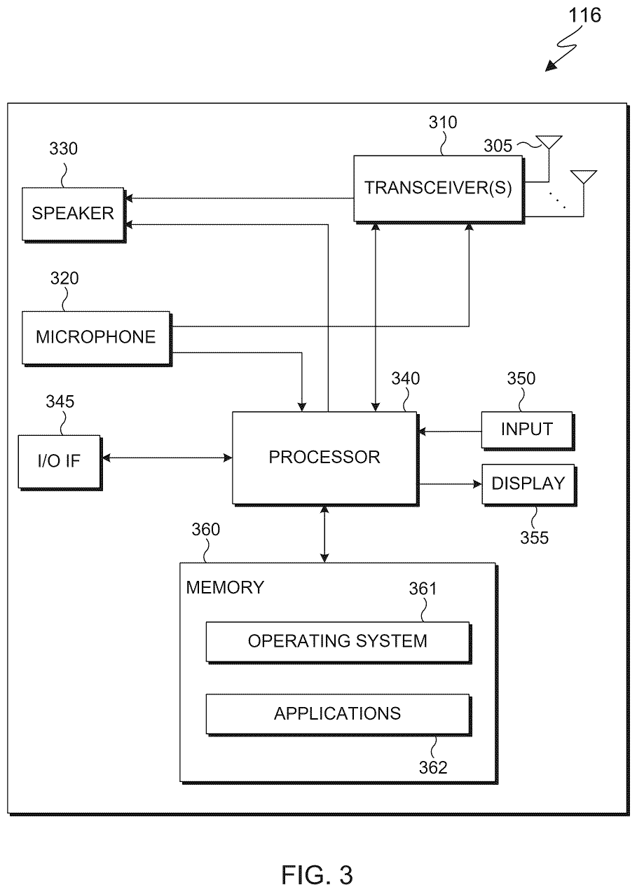

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for early SRS triggering as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

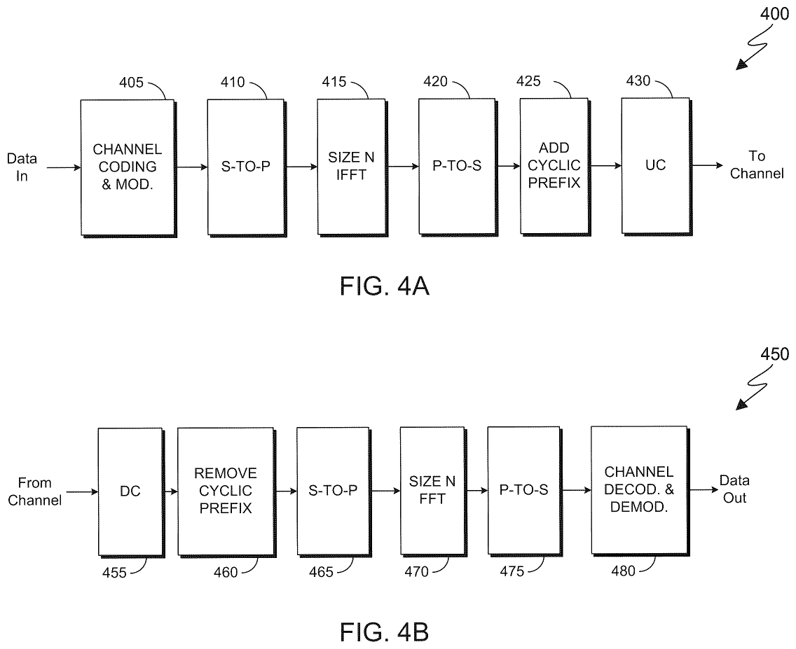

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting early SRS triggering as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where Nis the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In this disclosure, a beam can be determined by any of:
A TCI state, that establishes a quasi-colocation (QCL) relationship or spatial relation between a source reference signal (e.g. SSB and/or CSI-RS) and a target reference signal, and
A spatial relation information that establishes an association to a source reference signal, such as SSB or CSI-RS or SRS.
   In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

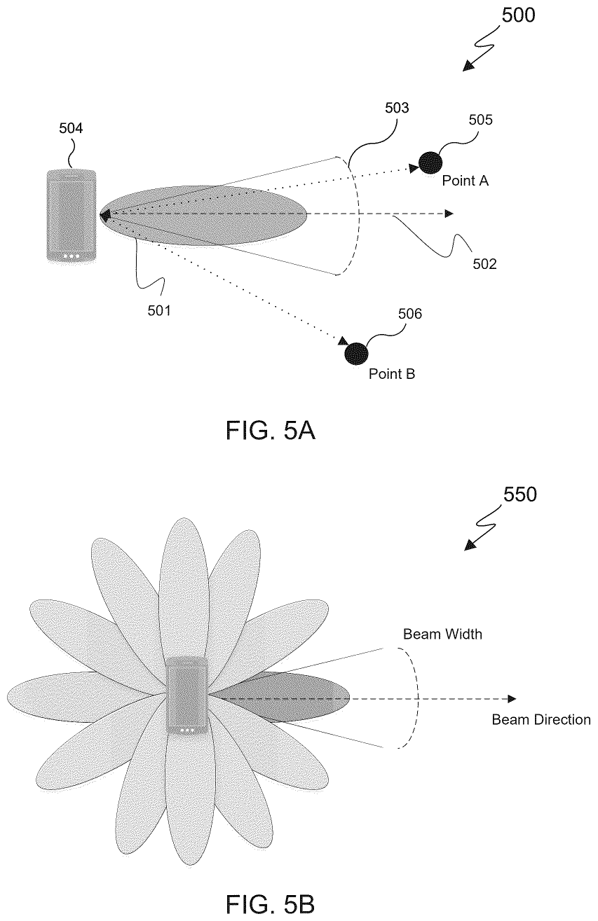

FIG. 5A illustrates an example beam operation 500 in a wireless communication system according to embodiments of the present disclosure. For example, beam operation 500 can be implemented by BS 102 and/or any of the UEs 111-116 of FIG. 1. This example is for illustration only and other embodiments can be used without departing from the scope of the present disclosure.

As illustrated in FIG. 5A, in a wireless system, a beam (501), for a device (504), can be characterized by a beam direction (502) and a beam width (503). For example, a device (504) transmits radio frequency (RF) energy in a beam direction and within a beam width. A device (504) receives RF energy in a beam direction and within a beam width. As illustrated in FIG. 5A, a device at point A (505) can receive from and transmit to device (504) as Point A is within a beam width and direction of a beam from device (504). As illustrated in FIG. 5A, a device at point B (506) cannot receive from and transmit to device (504) as Point B is outside a beam width and direction of a beam from device (504). While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example multi-beam operation 550 in a wireless communication system according to embodiments of the present disclosure. For example, multi-beam operation 550 can be implemented by BS 102 and/or any of the UEs 111-116 of FIG. 1. This example is for illustration only and other embodiments can be used without departing from the scope of the present disclosure.

As illustrated in FIG. 5B, in a wireless system, a device can transmit and/or receive on multiple beams. This is known as “multi-beam operation.” While FIG. 5B, for illustrative purposes, shows beams in 2D, it should be apparent to those skilled in the art that beams can be 3D, where the beams can be transmitted to or received from any direction in space.

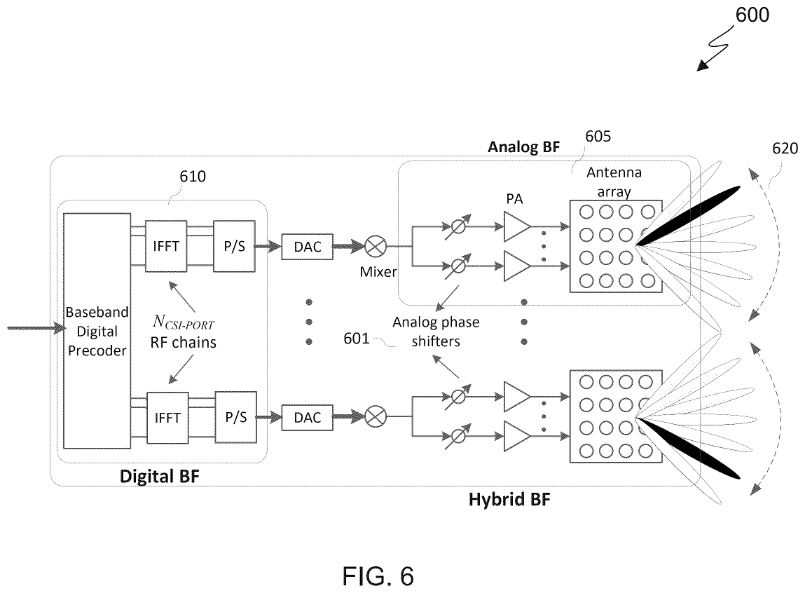

FIG. 6 illustrates an example of a transmitter structure 600 for beamforming according to embodiments of the present disclosure. In certain embodiments, one or more of BS 102 or UE 56 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam.

The system of FIG. 6 is also applicable to higher frequency bands such as >52.6 GHz. In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [38.214-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the MAC CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state can also be indicated in a purpose designed channel or DCI Format for TCI state indication. A TCI state (TCI state code point) indicated in a DL related DCI format or purpose design channel or DCI Format for TCI state indication is applied after a beam application time from the corresponding HARQ-ACK feedback.

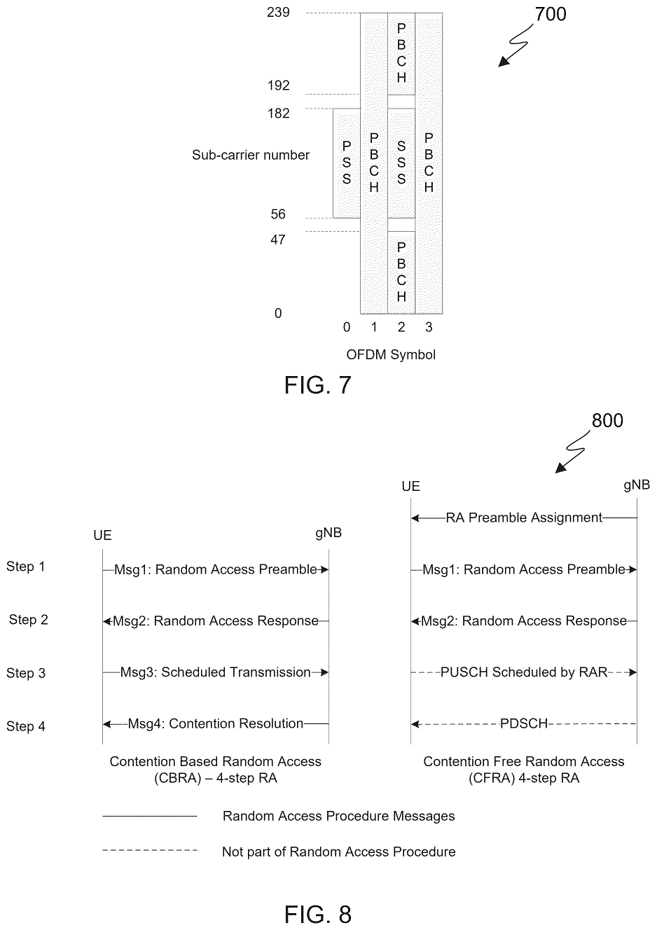

FIG. 7 illustrates an SSB 700 according to embodiments of the present disclosure. The SSB 700 is for example, and other implementations can be used in the present disclosure. In 5G/NR, a UE performs the cell search procedure to acquire time and frequency synchronization with a cell and to detect the physical layer Cell ID of the cell. To perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 resource blocks (RBs) (240 subcarriers), as illustrated in FIG. 7.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. For carrier frequencies less than or equal to 3 GHZ, N=4. For carrier frequencies in FR1 that are larger than 3 GHZ, N=8. For carrier frequencies in FR2, N=64. The SSB indices actually transmitted are provided by ssb-PositionsInBurst in system information block one (SIB1) or in ServingCellConfigCommon or in SSB-MTC-AdditionalPCI or in LIM-SSB-Config.

SSBs are transmitted periodically, wherein the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

NR introduced a physical random access channel (PRACH) to be used, among other cases, when the UE wants to communicate with the network and doesn't have uplink resources. For example, the physical random access channel can be used during initial access. The PRACH includes a preamble format comprising one or more preamble sequences transmitted in a PRACH Occasion (RO).

NR supports four different preamble sequence lengths:
Sequence length 839 used with sub-carrier spacings 1.25 kHz and 5 kHz with unrestricted or restricted sets.
Sequence length 139 used with sub-carrier spacings 15 kHz, 30 kHz, 60 kHz and 120 kHz with unrestricted sets.
Sequence length 571 used with sub-carrier spacing 30 kHz with unrestricted sets.
Sequence length 1151 used with sub-carrier spacing 15 kHz with unrestricted sets.

RACH preambles are transmitted in time-frequency resources PRACH Occasions (ROs). Each RO determines the time and frequency resources in which a preamble is transmitted, the resources allocated to an RO in the frequency domain (e.g., number of RBs) and the resource allocated to an RO in the time domain (e.g., number of OFDMA symbols or number of slots), depend on the preamble sequence length, sub-carrier spacing of the preamble, sub-carrier spacing of the PUSCH in the UL BWP, and the preamble format. Multiple PRACH Occasions can be FDMed in one time instance. This is indicated by higher layer parameter msg1-FDM. The time instances of the PRACH Occasions are determined by the higher layer parameter prach-ConfigurationIndex, and Tables 6.3.3.2-2, 6.3.3.2-3, and 6.3.3.2-4 of TS 38.211 v18.1.0.

SSBs are associated with ROs. The number of SSBs associated with one RO can be indicated by higher layer parameters such as ssb-perRACH-OccasionAndCB-PreamblesPerSSB and ssb-perRACH-Occasion. The number of SSBs per RO can be {⅛, ¼, ½, 1, 2, 4, 8, 16}. When the number of SSBs per RO is less than 1, multiple ROs are associated with the same SSB index. SS/PBCH block indexes provided by ssb-PositionsInBurst in SIB1 or in ServingCellConfigCommon or in SSB-MTC-AdditionalPCI or in LTM-SSB-Config are mapped to valid PRACH occasions in the following order [38.213 v18.1.0]:
First, in increasing order of preamble indexes within a single PRACH occasion.
Second, in increasing order of frequency resource indexes for frequency multiplexed PRACH occasions.
Third, in increasing order of time resource indexes for time multiplexed PRACH occasions within a PRACH slot.
Fourth, in increasing order of indexes for PRACH slots.

The association period starts from frame 0 for mapping SS/PBCH block indexes to PRACH Occasions.

A random access procedure can be initiated by a PDCCH order, by the MAC entity, or by RRC.

There are two types of random access procedures, type-1 random access procedure and type-2 random access procedure.

FIG. 8 illustrates a type-1 random access procedure 800 also known as four-step random access procedure (4-step RACH) according to embodiments of the present disclosure. The procedure 800 is for example, and other implementations can be used in the present disclosure.

As illustrated, the procedure 800 includes the following:
In step 1, the UE transmits a random access preamble, also known as Msg1, to the gNB. The gNB attempts to receive and detect the preamble.
In step 2, the gNB upon receiving the preamble transmits a RAR, also known as Msg2, to the UE including, among other fields, a time adjustment (TA) command and a RAR uplink grant for a subsequent PUSCH transmission.
In step 3, the UE after receiving the RAR, transmits a PUSCH transmission scheduled by the grant included in the RAR and time adjusted according to the TA received in the RAR. Msg3 or the PUSCH scheduled by the RAR UL grant can include the RRC reconfiguration complete message or RRC setup request.
In step 4, the gNB upon receiving the RRC reconfiguration complete message or RRC setup request, allocates downlink and uplink resources that are transmitted in a downlink PDSCH transmission to the UE.

After the last step, the UE can proceed with reception and transmission of data traffic.

Type-1 random access procedure (4-step RACH) can be contention based random access (CBRA) or contention free random access (CFRA). The CFRA procedure ends after the random access response, the following messages are not part of the random access procedure. For CFRA, in step 0, the gNB indicates to the UE the preamble to use.

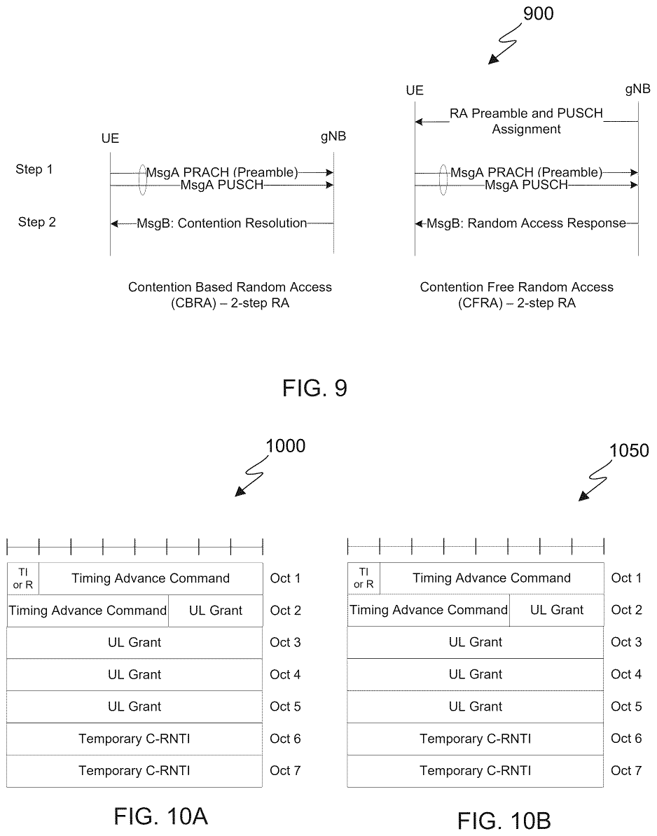

FIG. 9 illustrates a type-2 random access procedure, also known as 2-step random access procedure 900 (2-step RACH) according to embodiments of the present disclosure. The procedure 900 is for example, and other implementations can be used in the present disclosure.

Rel-16, introduced a new random access procedure the type-2 random access procedure, also known as 2-step random access procedure (2-step RACH). The procedure 900 combines the preamble and PUSCH transmission into a single transmission from the UE to the gNB, which is known as MsgA. Similarly, the RAR and the PDSCH transmission (e.g. Msg4) are combined into a single downlink transmission from the gNB to the UE, which is known as MsgB.

A random access procedure can be triggered for initial access from the RRC_IDLE state. During this procedure, a UE identifies an SS/PBCH block with index i and with an RSRP that exceeds a threshold. The RSRP threshold for SSB selection for RACH resource association is indicated by the network. The UE selects a RO and a preamble within the RO associated with SS/PBCH block index i. The UE transmits a PRACH using the selected RO/preamble. The UE monitors and receives the random access response (RAR), by attempting to detect a DCI format 1_0 with CRC scrambled by a corresponding RA-RNTI during a window controlled by higher layers. If the UE does not detect the DCI format 1_0 with CRC scrambled by the corresponding RA-RNTI within the RAR window, the UE may retransmit PRACH. If the UE detects the DCI format 1_0 with CRC scrambled by the corresponding RA-RNTI, the UE receives a RAR UL grant for the scheduling of a PUSCH. The UE transmits the PUSCH according to the RAR UL grant. In response to the PUSCH transmission scheduled by a RAR UL grant, when a UE has not been provided a C-RNTI, the UE attempts to detect a DCI format 1_0 with CRC scrambled by a corresponding TC-RNTI scheduling a PDSCH that includes a UE contention resolution identity. The spatial domain filters (beams) identified during initial access, are used for subsequent transmissions and receptions to/from the UE until a single TCI state is configured or activated or indicated to the UE. For downlink receptions when a UE does not have the TCI state, the spatial domain filter is that associated with the SS/PBCH block index identified during initial access. For uplink transmissions when a UE does not have the TCI state, the spatial domain filter is that used for PUSCH scheduled by the RAR UL grant.

FIG. 10A illustrates a MAC RAR 1000 according to embodiments of the present disclosure. The MAC RAR 1000 is for example, and other implementations can be used in the present disclosure.

For example, the MAC RAR 1000 may be used for the MAC RAR (for Type 1 random access procedure) (TS 38.321 FIG. 6.2.3-1), where:
R: Reserved bit, set to 0
TI: If two TAGs are configured for the Serving Cell in which the Random Access procedure is being performed, this field indicates one of the two TAGs to which the Timing Advance Command is applied

FIG. 10B illustrates a fallback RAR 1050 according to embodiments of the present disclosure. The fallback RAR 1050 is for example, and other implementations can be used in the present disclosure. For example, the fallback RAR 1050 may be used for the fallback RAR (for Type 2 random access procedure), which is used when MSGA PRACH is successfully received but MSGA PUSCH is not decoded correctly (38.321 FIG. 6.2.3a-1), where:
R: Reserved bit, set to 0
TI: If two TAGs are configured for the SpCell, this field indicates one of the two TAGs to which the Timing Advance Command is applied

FIG. 10C illustrates a success RAR 1070 according to embodiments of the present disclosure. The success RAR 1070 is for example, and other implementations can be used in the present disclosure. For example, the success RAR 1070 may be used for the success RAR (for Type 2 random access procedure), which is used when MSGA PRACH is successfully received and MSGA PUSCH is decoded correctly (38.321 FIG. 6.2.3a-2).

In one example, the UL grant in the MAC RAR or fallbackRAR is given by Table 1 below.

TABLE 1

| RAR grant field | Number of bits |
|---|---|
| Frequency hopping flag | 1 |
| PUSCH frequency resource | 12, for operation with shared spectrum channel |
| allocation | access in FR1 or for FR2-2 when |
| | ChannelAccessMode2-r17 is provided |
| | 14, otherwise |
| PUSCH time resource allocation | 4 |
| MCS | 4 |
| TPC command for PUSCH | 3 |
| CSI request | 1 |
| ChannelAccess-CPext | 2, for operation with shared spectrum channel |
| | access in FR1 or for FR2-2 when |
| | ChannelAccessMode2-r17 is provided |
| | 0, otherwise |

SRS is an uplink reference signal that is used for sounding (i.e., channel quality estimation) the uplink channel between the UE and the gNB. In case of reciprocity between UL and DL, the channel sounding of the uplink channel can also be used for link adaptation and precoding on the downlink channel from the gNB to the UE. SRS is transmitted independent of data transmissions on the uplink. The SRS usage can be one of: beamManagement, codebook, nonCodebook, antennaSwitching, this is in addition to SRS for positioning.

In NR SRS resources are configured by the network, for example, as part of RRC setup or RRC reconfiguration. SRS resources are configured in SRS resource set. An SRS resource set includes a set of SRS resources, and defines the following parameters: (1) resourceType, which determine the time domain behavior of SRS, SRS can be aperiodic, semi-persistent or periodic. (2) usage, which can be one of: beamManagement, codebook, nonCodebook or antennaSwitching. (3) information related to power control and TCI state.

The configuration of the SRS resource includes the following: (1) information related to the transmission comb, including comb size, comb offset and cyclic shift. (2) Information related to time domain resource mapping including starting symbol within a slot, number of SRS symbols and repetition factor. (3) information related to frequency domain including freqDomainPosition N_RRC, freqDomainShift n_shift, and frequency hopping parameters c-SRS, b-SRS, and b-hop. (4) Information related to group or sequence hopping, whether one of them or neither is enabled. (5) for periodic and semi-persistent SRS, the periodicity and offset of the SRS resource. (6) Sequence ID. (7) Information related to the TCI state or spatial relation info.

In 5G NR, a UE can transmit a sounding reference signal (SRS). A SRS resource is configured by higher layer IE SRS-Resource.

The SRS sequence is a low PAPR sequence of length

$${N}_{ZC} = {M}_{sc , b}^{SRS}$$

given by:

$${r}^{( p )} ( n , {l}^{′} ) = {r}_{u , v}^{( a , δ )} ( n ) = {e}^{jan} {\overline{r}}_{u , v} ( n ) , 0 \leq n < {M}_{ZC}$$

$$where {M}_{ZC} = {mN}_{sc}^{RB} / {2}^{δ} , δ = log ( {K}_{TC} ) ,$$

with K_{TC} being the transmission comb number is provided in higher layer IE transmissionComb, K_{TC}∈{2,4,8}. l′ is the SRS symbol within a SRS resource of a slot,

$${l}^{′} ∈ \{ 0 , 1 , … , {N}_{symb}^{SRS} - 1 \} , {N}_{symb}^{SRS}$$

is the number of SRS symbols in a slot. The cyclic shift αᵢ for antenna port pᵢ is given by

$${α}_{i} = 2 π \frac{{n}_{SRS}^{cs , i}}{{n}_{SRS}^{cs , max}} , and {n}_{SRS}^{cs , i} = ( {n}_{SRS}^{cs} + \frac{{n}_{SRS}^{cs , max} ( {p}_{i} - 1000 )}{{N}_{ap}^{SRS}} ) mod {n}_{SRS}^{cs , max}$$

with

$${n}_{SRS}^{cs}$$

being provided by higher layer in IE transmissionComb,

$${n}_{SRS}^{cs , max}$$

depends on K_{TC} as illustrated in Table 2.

TABLE 2

| K_{TC} | ${n}_{SRS}^{cs , max}$ |
|---|---|
| 2 | 8 |
| 4 | 12 |
| 8 | 6 |

u is the group number u∈{0, 1, . . . , 29}, v is the base sequence number, with v∈{0}, if 6≤N_{ZC}≤60 and ∈{0}, if 60<N_{ZC}. The base sequence, r̅_{u,v}(n), is generated as follows:
1. For N_{ZC}∈{6,12,18,24}, r̅_{u,v}(n)=e^{jφ(n)π/4}, with 0≤n<M_{ZC}−1. φ(n) is given by Tables 5.2.2.2-1 to 5.2.2.2-4 of TS 38.211.
2. For N_{ZC}=30,

$${\overline{r}}_{u , v} ( n ) = {e}^{- j \frac{π ( u + 1 ) ( n + 1 ) ( n + 2 )}{31}} ,$$

with 0≤n<M_{ZC}−1.
3. For N_{ZC}≥30, r̅_{u,v}(n)=x_{q}(n mod N_{ZC}),

$${x}_{q} ( n ) = {e}^{- j \frac{π qm ( m + 1 )}{{N}_{ZC}}} .$$

N_{ZC} is the largest prime number less than M_{ZC}. q=└q̅+½┘+v·(−1)^{|2q̅|}

$$\overline{q} = {N}_{ZC} \frac{u + 1}{31} .$$

The sequence group u is given by:

$$u = ( {f}_{gh} ( {n}_{s , f}^{μ} , {l}^{′} ) + {n}_{ID}^{SRS} ) . Where , {n}_{ID}^{SRS}$$

is provided by higher layer parameter sequenceID, with

$${n}_{ID}^{SRS} ∈ \{ 0 , 1 , … , 65535 \} .$$

Higher layer parameter groupOrSeqeunceHopping determines the values of u and v:
if groupOrSequenceHopping equals ‘neither’, neither group, nor sequence hopping shall be used and

$${f}_{gh} ( {n}_{s , f}^{μ} , {l}^{′} ) = 0 ,$$

and v=0.
if groupOrSequenceHopping equals ‘groupHopping’, group hopping but not sequence hopping is used and v=0, and

$${f}_{gh} ( {n}_{s , f}^{μ} , {l}^{′} ) = ( {\sum }_{m = 0}^{7} c ( 8 ( {n}_{s , f}^{μ} {N}_{symb}^{slot} + {l}_{0} + {l}^{′} ) + m ) \cdot {2}^{m} ) mod 30 , {N}_{symb}^{slot}$$

is the number of symbols in a slots, l₀ is the first SRS symbols in the slot, and c(n) a length-31 Gold sequence defined as c(n)=(x₁(n+N_{c})+x₂ (n+N_{c})) mod 2, with N_{c}=1600, x₁ (n+31)=(x₁(n+3)+x₁(n) mod 2, x₂(n+31)=(x₂(n+3)+x₂(n+2)+x₂(n+1)+x₂ (n)) mod 2, the first m-sequence is initialized with x₁ (0)=1, and x₁ (n)=0, for n=1 . . . 30. The second m-sequence is initialized with cᵢₙᵢₜ, where

$${c}_{init} = {n}_{ID}^{SRS}$$

if groupOrSequenceHopping equals ‘sequenceHopping’, sequence hopping but not group hopping is used and

$${f}_{gh} ( {n}_{s , f}^{μ} , {l}^{′} ) = 0$$

and

$$v = \{ \begin{matrix}c ( {n}_{s , f}^{μ} {N}_{symb}^{slot} + {l}_{0} + {l}^{′} ) & {M}_{sc , b}^{SRS} \geq 6 {N}_{sc}^{RB} \\ 0 & otherwise\end{matrix}$$

$${N}_{symb}^{slot}$$

is the number of symbols in a slots, l₀ is the first SRS symbols in the slot, and c(n) a length-31 Gold sequence as previously defined.

The SRS sequence, r^{(p)}(n, l′), is mapped to resource elements

$${a}_{k , l}^{( p )}$$

within a slot, where K is the sub-carrier frequency, l is the symbol number within the slot and p is the antenna port, where for SRS there is one antenna port, by

$${a}_{k , l}^{( p )} = {β}_{SRS} {r}^{( p )} ( {k}^{′} , {l}^{′} )$$

$$Where : l = {l}^{′} + {l}_{0}$$

β_{SRS} is a scaling factor,

$${k}^{′} = 0 , 1 , … , {M}_{sc , b}^{SRS} - 1 , {M}_{sc , b}^{SRS} = {m}_{SRS , b} {N}_{sc}^{RB} / {K}_{TC} ,$$

m_{SRS,b} is provided by Table 6.4.14.3-1 of TS 38.211, and

$${l}^{′} = 0 , 1 , … , {N}_{symb}^{SRS} - 1.$$

l=l′+l₀, with l₀ the first SRS symbols in the slot, where l₀∈{0, 1, . . . , 13}.

$$k = {K}_{TC} {k}^{′} + {k}_{0}^{( {p}_{i} )} ,$$

K_{TC} is the transmission comb number as previously described,

$${k}_{0}^{( p )} = {\overline{k}}_{0}^{( p )} + {\sum }_{b = 0}^{{B}_{SRS}} {K}_{TC} {M}_{sc , b}^{SRS} {n}_{b} , {\overline{k}}_{0}^{( {p}_{i} )} = {n}_{shift} {N}_{sc}^{RB} + ( {k}_{TC}^{( {p}_{i} )} + {k}_{offset}^{{l}^{′}} ) mod {K}_{TC} , {k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ \frac{{n}_{SRS}^{cs , max}}{2} , … , {n}_{SRS}^{cs , max} - 1 \} and {N}_{ap}^{SRS} = 4 and {p}_{i} ∈ \{ 1001 , 1003 \} \\ {\overline{k}}_{TC} & otherwise\end{matrix}$$

k̅_{TC} is the transmission comb offset included within higher layer IE transmissionComb, with k̅_{TC}∈{0, 1, . . . , K_{TC}−1},

$${k}_{offset}^{{l}^{′}}$$

is a symbol dependent sub-carrier offset given by Table 3, n_{shift} is given by higher layer parameter freqDomainShift and it adjust the frequency allocation with respect to a reference point. If

$${N}_{BWP}^{start} \leq {n}_{shift}$$

the reference point for

$${k}_{0}^{( p )}$$

is sub-carrier 0 in common resource block 0, otherwise the reference point is the lowest subcarrier of the BWP. n_{b} is a frequency positioning index. n_{b} is given by:

$${n}_{b} = ⌊ \frac{4 {n}_{RRC}}{{m}_{SRS , b}} ⌋ mod {N}_{b}$$

n_{RRC} is given by higher layer parameter freqDomainPosition, and m_{SRS,b} and N_{b} are determined by Table 6.4.14.3-1 of TS 38.211 with b=B_{SRS} and the configured value of C_{SRS}.

TABLE 3

| | ${k}_{offset}^{0} , {k}_{offset}^{1} , … , {k}_{offset}^{{N}_{symb}^{SRS} - 1}$ | | | | |
|---|---|---|---|---|---|
| K_{TC} | ${N}_{s y m b}^{S R S} = 1$ | ${N}_{s y m b}^{S R S} = 2$ | ${N}_{s y m b}^{S R S} = 4$ | ${N}_{s y m b}^{S R S} = 8$ | ${N}_{s y m b}^{S R S} = 12$ |
| 2 | 0 | 0, 1 | 0, 1, 0, 1 | — | — |
| 4 | — | 0, 2 | 0, 2, 1, 3 | 0, 2, 1, 3, 0, 2, 1, 3 | 0, 2, 1, 3, 0, 2, 1, 3, 0, |
| | | | | | 2, 1, 3 |
| 8 | — | — | 0, 4, 2, 6 | 0, 4, 2, 6, 1, 5, 3, 7 | 0, 4, 2, 6, 1, 5, 3, 7, 0, |
| | | | | | 4, 2, 6 |

In NR paging is used to alert idle and inactive UEs of incoming calls, messages and data. Paging is used to trigger RRC setup (e.g., RRC setup request or RRC connection resumption).

Paging is transmitted over the paging channel (PCH). The paging message includes a paging record list, which is a list of UEs being paged, each identified by a TMSI or an I-RNTI. The 5G S-Temporary Mobile Subscription Identifier (5G-S-TMSI), a temporary UE identity provided by the 5GC which uniquely identifies the UE within the tracking area. The I-RNTI is used to identify the suspended UE context of a UE in RRC_INACTIVE.

The following messages describe the contents of a paging message:

| | |
|---|---|
| PCCH-Message ::= | SEQUENCE { |
| message | PCCH-MessageType |

}

| | |
|---|---|
| PCCH-MessageType ::= | CHOICE { |
| c1 | CHOICE { |
| paging | Paging, |

```
    spare1 NULL
  },
```

| | |
|---|---|
| messageClassExtension | SEQUENCE { } |

}

| Paging ::= | SEQUENCE { | |
|---|---|---|
| pagingRecordList | PagingRecordList | OPTIONAL, - |

- Need N

| | |
|---|---|
| lateNonCriticalExtension | OCTET STRING |

OPTIONAL,

| | | |
|---|---|---|
| nonCriticalExtension | Paging-v1700-IEs | OPTIONAL |

}

| PagingRecordList ::= | SEQUENCE (SIZE(1..maxNrofPageRec)) OF PagingRecord | |
|---|---|---|
| PagingRecord ::= | SEQUENCE { | |
| ue-Identity | PagingUE-Identity, | |
| accessType | ENUMERATED {non3GPP} | OPTIONAL, -- Need N |

...
}

| | |
|---|---|
| PagingUE-Identity ::= | CHOICE { |
| ng-5G-S-TMSI | NG-5G-S-TMSI, |
| fullI-RNTI | I-RNTI-Value, |

...
}

| | |
|---|---|
| NG-5G-S-TMSI ::= | BIT STRING (SIZE (48)) |
| I-RNTI-Value ::= | BIT STRING (SIZE(40)) |

A UE may use Discontinuous Reception (DRX) in RRC_IDLE and RRC_INACTIVE state in order to reduce power consumption. The UE monitors one paging occasion (PO) per DRX cycle, T. Where, a PO is a set of PDCCH monitoring occasions and can include multiple time slots where paging DCI can be sent. A Paging Frame (PF) is one Radio Frame and may contain one or multiple PO(s) or starting point of a PO.

The PF and PO for paging are determined by the following equations:
SFN of the PF is determined by: (SFN+PF_offset) mod T=(T div N)*(UE_ID mod N)
The index i_s of the PO is determined by: i_s=floor (UE_ID/N) mod Ns

### Where,

T is the DRX cycle of the UE, determined by the shortest of the UE specific DRX value(s) and a default DRX value included in SIB1. (1) For CN-initiated paging, a default cycle is broadcast in system information. (2) For CN-initiated paging, a UE specific cycle can be configured via NAS signaling. (3) For RAN-initiated paging, a UE-specific cycle is configured via RRC signaling. A UE in RRC_IDLE uses the shortest of (1) and (2). A UE in RRC_INACTIVE uses the shortest of (1), (2) and (3).
N is a number of total paging frames in T, provided by nAndPagingFrameOffset in SIB1.
Ns is a number of paging occasions for a PF, provided by ns in SIB1
PF_offset is an offset used for PF determination, provided by nAndPagingFrameOffset in SIB1.
UE ID: 5G-S-TMSI mod 1024

To minimize or reduce the probability of paging false alarms, which occur when a UE decodes the PCH due to another UE assigned to the same PO being paged, UEs assigned to the same PO are divided in into sub-groups, a DCI carrying a paging early indication (PEI) is transmitted before the corresponding PO to indicate the sub-groups with paging messages in the PO. A UE that is not in the indicated sub-groups indicated by the PEI doesn't decode the corresponding PO. There can be up to 8 sub-groups. The subgroups can be CN controlled sub-groups (determined by the access and mobility function (AMF)), and/or UE-ID based sub-groups.

DCI format 2_7 is used for notifying the paging early indication and TRS availability indication for one or more UEs. DCI Format 2_7 has a CRC scrambled by PEI RNTI. DCI Format 2_7 includes: (1) a paging indication field of size

$${N}_{PO}^{PEI} \cdot {N}_{SG}^{PO} , where , {N}_{PO}^{PEI}$$

is the number of paging occasions configured by higher layer parameter po-NumPerPEI, and

$${N}_{S G}^{PO}$$

is the number of sub-groups of a paging occasion configured by higher layer parameter subgroupsNumPerPO. Each bit in the field indicates one UE subgroup of a paging occasion. (2) TRS availability indication, which can be of size 1-6 bits, where the number of bits is equal to one plus the highest value of all the indBitID(s) provided by the trs-ResourceSetConfig if configured; 0 bits otherwise. Each TRS resource set is configured with an ID i for the association with (i+1)-th indication bit.

This disclosure provides for early triggering of SRS for UEs in RRC_IDLE or RRC_INACTIVE states when the network has data to send to the UE or the UE has data send to network. Early SRS transmission, can assist in determining the channel conditions and better link adaptation and better precoding for downlink and uplink transmissions. This disclosure provides for physical layer mechanisms as well as higher layer mechanisms for the network to trigger SRS transmission. The triggering of SRS can be during or associated with a random access procedure for RRC setup or RRC reconfiguration.

When a UE is in RRC_IDLE state or RRC_INACTIVE state, and data arrives at the network for the UE, or data arrives at the UE for the network, the UE through RRC setup procedure or RRC reconfiguration procedure transitions to the RRC_CONNECTED state. After transition to the RRC_CONNECTED state the network can trigger SRS transmission from the UE for channel quality estimation and the UE can start transmitting and receiving data. The SRS triggered can be wideband SRS or sub-band SRS, which would require several SRS transmission instances to provide an estimate of the channel quality of the full bandwidth. This process, i.e., the estimation of the channel quality, can take tens of milli-seconds, and even longer with sub-band SRS. Data transmission/reception can be delayed until the channel quality has been estimated using SRS, hence increasing latency. Alternatively, data transmission/reception can proceed in parallel with the SRS transmission and by the time the channel quality is estimated, the data (depending on the amount of data) has already or mostly been transmitted or received, hence rendering the channel quality estimation less useful while preceding transmissions/receptions from/to the UE are with reduced spectral efficiency due to the absence of a channel estimate at the gNB for the UE.

To mitigate this issue, it is beneficial to have the channel quality estimated in parallel with the RRC setup procedure, or RRC reconfiguration procedure such that when the UE is ready to transmit or receive data at the completion of the setup or reconfiguration procedures, the channel quality has already been estimated and link adaptation and precoding for uplink or downlink data is based on the estimated channel quality. Hence, there is a benefit for transmitting SRS in parallel with RRC setup procedure, or RRC reconfiguration procedure to reduce latency.

When the network initiates a communication session, the UE is first paged, and this is then followed by a random access (RA) or also referred to as RACH procedure. When the UE initiates a communication session, a RACH procedure is used. This disclosure also provides for signalling and methods for triggering SRS during a RACH procedure or associated with a RACH procedure. In one example, SRS can be triggered using a message separate from the RACH procedure messages. In another example, SRS can be triggered using a RACH procedure message, e.g., SRS can be triggered within RACH msg2 (RAR), or RACH msg4 (e.g., PDSCH message for contention resolution, e.g., containing contention resolution identity) for type-1 random access procedure, or RACH msgB for type-2 random access procedure. SRS transmission can be separate from the RACH procedure messages or can be transmitted in conjunction with the RACH procedure messages. In one example, the UE capability to support early SRS and/or SRS antenna switching capability can be indicated to the network in the RACH procedure messages (e.g., in Msg1, Msg3, or MsgA (in the PRACH part of MsgA and/or PUSCH part of MsgA). In one example, a UE context is stored in the network (e.g., when the UE is in the RRC_INACTIVE state), the UE context contains the UE capability to support early SRS and/or SRS antenna switching capability, when the network associates the UE triggering the random-access procedure with the UE context, the network can determine the UE capability.

The present disclosure relates to a 5G/NR and/or 6G communication system.

This disclosure provides for aspects related to design of early triggering of SRS for UEs in RRC_IDLE and RRC_INACTIVE states. This disclosure includes but is not limited the following aspects:
Triggering container or message of early SRS.
Timing of triggering of SRS in relation to random access procedure.
Transmission of SRS in relation to RACH procedure transmissions.
Signaling and determination of SRS resource.
Signaling of UE capability to support early SRS and SRS antenna switching capability.

In the following, both FDD and TDD are provided as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure provides several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH and/or DL control information on PDSCH), DCI can be one stage/part DCI or two-stage/part DCI and/or (2) UL control information (e.g., UCI on PUCCH or PUSCH). L1 control signaling be UE-specific e.g., to one UE and can be UE common (e.g., for a group of UEs or for all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L (i), where i can take N values, and L (i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In this disclosure Msg5 refers to the message transmitted by the UE in response to Msg4. For example, Msg5 can be connection setup complete or resume complete.

Terminology such as TCI, TCI states, SpatialRelationInfo, target RS, reference RS, Msg1, Msg2, Msg3, Msg4, Msg5, MsgA, MsgB and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part).

In this disclosure, a higher layer message (e.g., SIB-based or RRC-based or MAC CE-based) can be carried by a physical downlink shared channel (PDSCH). In one example, the PDSCH can be scheduled by a DCI format.

In one example, the configuration of early SRS resources can be configured or updated, by RRC signaling and/or MAC CE signaling and/or L1 control signaling.

In one example, the configuration of the SRS resource(s) and SRS resource set(s) can include:
SRS resource(s) in SRS resource set.
SRS resource ID
Time and frequency resources (e.g., symbols within a slot for SRS, starting symbol for SRS, number of repetitions, time slot for SRS, periodicity and offset of SRS (e.g., in case of periodic or semi-persistent SRS), starting RB for SRS, number of RBs for SRS, whether frequency hopping is enabled and if enabled frequency hopping pattern, etc.).
Number of instances, K, of SRS transmitted when SRS is triggered.
Comb size, comb offset and cycle shift.
Sequence for reference signal.
Power for reference signal.
SRS usage, e.g., beamManagement, codebook, nonCodebook, antennaSwitching. In one example, SRS usage is antennaSwitching.

In this disclosure SRS antenna switching capability refers to the UE's SRS antenna switching capability or the UE's SRS antenna switching configuration or SRS antenna switching resource configuration.

In one example, SRS resource configuration can include supportedSRS-TxPortSwitch, wherein supportedSRS-TxPortSwitch can be {t1r2 for 1T2R, t1r4 for 1T4R, t2r4 for 2T4R, t1r4-t2r4 for 1T4R/2T4R, t1r1 for 1T=1R, t2r2 for 2T=2R, t4r4 for 4T=4R, notSupported}. In one example, a UE can select SRS resources based on UE's antenna switching capability or capabilities. In one example, the antenna switching capability can be one of {“Not supported”, “1T2R”, “1T4R”, “2T4R”, “1T4R/2T4R”, “1T=1R”, “2T=2R”, “4T=4R”}. In one example, if a UE antenna switching capability is unknown at the time of triggering or of transmission of the early SRS a default capability can is used. In one example, the default capability is “antenna switching not supported”. In one example, the default capability is 1T2R. In one example, the default capability is 1T=1R. In one example, the default capability is configured by the SIB, e.g. SIB1. In one example, the resource used for early SRS are determined based on the antenna switching capability as described in TS 38.214 clause 6.2.1.2. For example,
For 1T2R, two SRS resources transmitted in different symbols, each SRS resource in a given set including a single SRS port, and the SRS port of the second resource in the set is associated with a different UE antenna port than the SRS port of the first resource in the same set.
For 2T4R, two SRS resources transmitted in different symbols, each SRS resource in a given set including two SRS ports, and the SRS port pair of the second resource is associated with a different UE antenna port pair than the SRS port pair of the first resource.
For 1T4R, four SRS resources transmitted in different symbols of two different slots, and where the SRS port of each SRS resource in the given two sets is associated with a different UE antenna port.
For 1T=1R, or 2T=2R, or 4T=4R, one SRS resource, where the number of SRS ports for each resource is equal to 1, 2, or 4 respectively.

In aforementioned examples, the configuration of early SRS can include multiple SRS (e.g., 2) resource sets for each antenna switching capability, wherein a first resource set is for type periodic or semi-persistent SRS, and a second resource set is for type aperiodic SRS.

In a variant example, SRS resource configuration can include supportedSRS-TxPortSwitch, wherein supportedSRS-TxPortSwitch can be (‘t1r2’ for 1T2R, ‘t1r1-t1r2’ for 1T=1R/1T2R, ‘t2r4’ for 2T4R, ‘t1r4’ for 1T4R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t1r1-t1r2- t2r2-t1r4-t2r4’ for 1T=1R/1T2R/2T=2R/1T4R/2T4R, ‘t1r1’ for 1T=1R, ‘t2r2’ for 2T=2R, ‘t1r1-t2r2’ for 1T=1R/2T=2R, ‘t4r4’ for 4T=4R, or ‘t1r1-t2r2-t4r4’ for 1T=1R/2T=2R/4T=4R), or the UE may be configured with only one of the following configurations depending on the indicated UE capability or capabilities supportedSRS-TxPortSwitchBeyond4Rx (‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R) or the UE may be configured with the following configurations depending on the indicated UE capability (or capabilities) [e.g., newUECapabilitySupporting8T8R] (‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘[noTDM]’ or ‘[TDM and noTDM]’ for 8T8R). In one example, if a UE antenna switching capability is unknown at the time of triggering or of transmission of the early SRS a default capability can be used. In one example, the default capability is “antenna switching not supported”. In one example, the default capability is 1T2R. In one example, the default capability is 1T=1R. In one example, the default capability is configured by the SIB. In one example, the resource used for early SRS are determined based on the antenna switching capability as described in TS 38.214 clause 6.2.1.2.

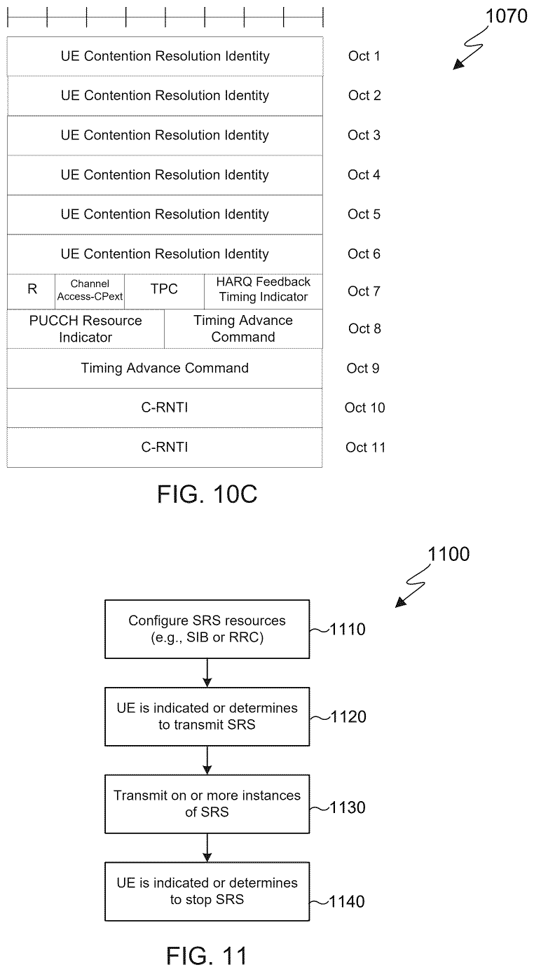

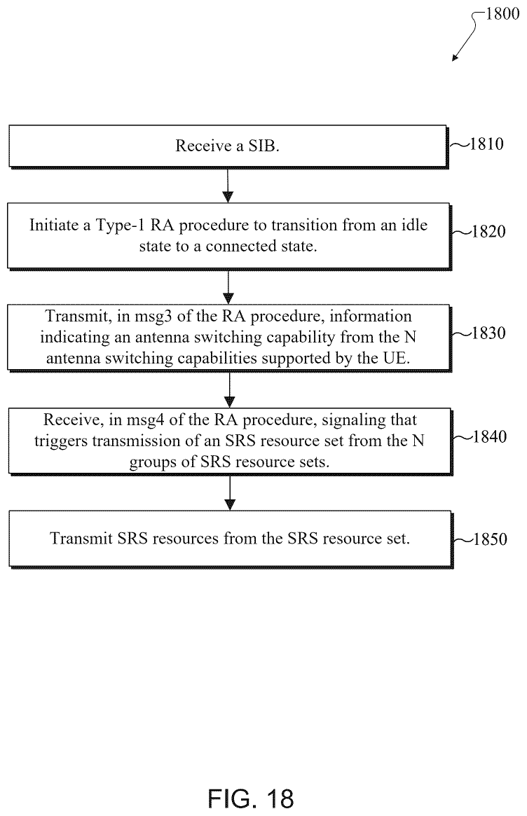

FIG. 11 illustrates an example procedure 1100 for SRS triggering according to embodiments of the present disclosure. For example, procedure 1100 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

As illustrated in FIG. 11, a UE can be configured with SRS resources and/or SRS resource sets by system information (e.g., system information block (SIB), e.g., SIB1 or other SIB) or by RRC configuration (1110). The UE can be indicated or determines to transmit SRS (1120). In one example, the indication/determination can be by a message associated with a random access (e.g., RACH) procedure. In one example, the indication can be by a message for triggering SRS transmission. The UE, based on the indication or determination of SRS transmission, and the configured SRS resources, transmits SRS in one or more SRS transmission instances (1130). In one example, the transmission is one-shot (e.g., one SRS transmission instance, or one SRS transmission instance per subband). In one example, the transmission is N-shot (e.g., N SRS transmission instances, or N SRS transmission instances per subband). In one example, the transmission is periodic. In one example, a UE can optionally determine or is indicated to stop SRS transmission (for example in case of periodic SRS transmission, or in case of N-shot SRS transmission) (1140).

In the examples, of this disclosure, the gNB or network sends a message to a UE (or to a group of UEs), and the message triggers a transmission of a SRS resource. In one example, the UE transmitting the SRS can be intended receiver of the message, for example this can be a random access response (RAR) to the UE that transmitted the preamble, or a MsgB to the UE that transmitted a MsgA for a type-2 random access procedure, or a contention resolution message or Msg4 to a UE that transmitted Msg3 of the random access procedure, or a message triggering SRS transmission.

In one example, resources used for SRS transmission, can be one of a set or group of resources configured by the network, e.g., by system information (e.g., SIB1 or other SIB) or RRC configuration. The SRS resource set ID and/or the SRS resource ID can be indicated or determined as described in this disclosure. In one example, when an SRS resource set ID and/or an SRS resource ID is indicated or determined, a subset of SRS resource sets or SRS resources is determined as described in this disclosure and a resource within the subset is indicated as described in this disclosure. In one example, when an SRS resource set ID and/or an SRS resource ID is indicated or determined, a subset of SRS resources is indicated as described in this disclosure and a resource within the subset is determined as described in this disclosure.

In one example, the configuration of the SRS resource parameters or a subset of the SRS resource parameters can be indicated to the UE in the message triggering the SRS transmission.

In one example, the time (slot/symbols) of the SRS transmission (e.g., the first instance of the SRS transmission) can be relative to the message or channel from the network triggering the SRS transmission. In one example, the time of the SRS transmission (e.g., the first instance of the SRS transmission) can be relative to a message or channel of the random access procedure. In one example, the time of the SRS transmission can be included in the information triggering the SRS transmission.

In one example, an SRS transmission triggered as described in this disclosure can be one of:
A single instance SRS transmission. In one example, the single transmission instance is for the SRS resource. In one example, the single transmission instance is per sub-band of SRS.
K instances of SRS transmissions. Wherein, K can be defined in the system specifications and/or configured or updated by system information and/or RRC signaling and/or MAC CE signaling and/or L1 control signaling. In one example, K can be indicated in the message triggering the SRS transmission. In one example, the K transmission instances are for the SRS resource (e.g., these can over a wideband or multiple sub-bands). In one example, the K transmission instances are per sub-band of SRS (e.g., each sub-band of SRS is transmitted in K transmission instances). Optionally, the UE can be indicated or determines to early terminate SRS transmissions.
A periodical or semi-persistent transmission until a reconfiguration message or deactivation message is transmitted to the UE, e.g., to stop the SRS transmission.

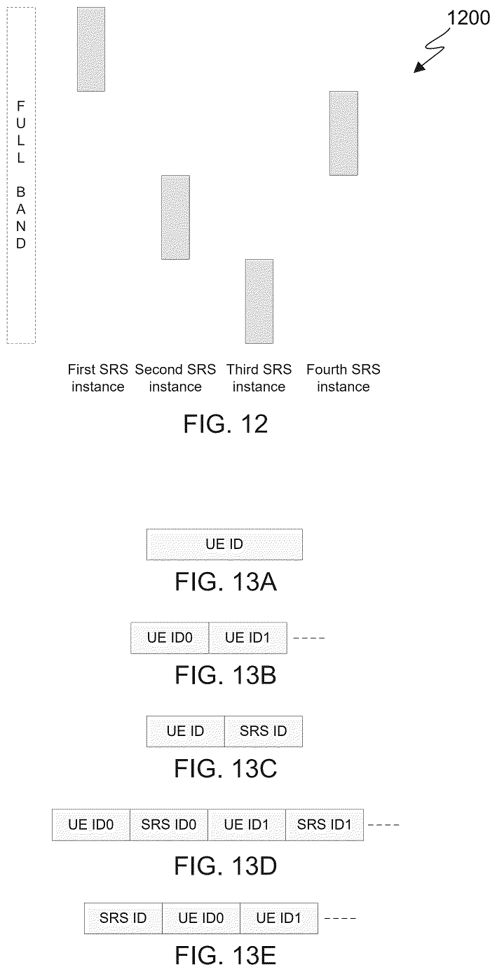

FIG. 12 illustrates an example of SRS instances 1200 in a band according to embodiments of the present disclosure. The SRS instances 1200 are for illustration only and other embodiments can be used without departing from the scope of the present disclosure.

In one example, SRS is sub-band SRS. The number of sub-bands within the full band is N. In one example, SRS is transmitted K times when triggered. In one example K=N, In one example, K>=N. In one example, a hopping pattern is used to sweep the SRS transmission in the different sub-bands, as illustrated in FIG. 12. As illustrated, the SRS instances are with 4 sub-bands in the full band (i.e., N=4). SRS is transmitted in 4 different SRS instances at different frequency locations to estimate the quality of the channel in the full band.

Various embodiments of the present disclosure provide for a standalone DL transmission to trigger SRS. In one example, the SRS is triggered by a DCI format. In one example, the DCI format includes a UE ID. In one example, the UE ID is a UE ID assigned or allocated by the core network, for example S-Temporary Mobile Subscription Identifier (S-TMSI or NG 5G S-TMSI). In one example, the UE ID is part of (or related to) the UE ID assigned by the core network, e.g. indicted UE ID is the n least significant bits of the UE ID, or indicted UE ID is the n most significant bits of the UE ID, or indicated ID is UE ID % N, or indicated ID is ceiling (UE ID/N). Where, % is the modulus function, where x % y is the remainder of dividing x by y. In one example, the UE ID is a UE ID assigned or allocated by the radio access network (RAN). In one example, UE ID is the I-RNTI. In one example, the UE-ID is a short I-RNTI (e.g., 24 bits of the I-RNTI). In one example, the UE ID is a long I-RNTI (e.g., 40 bits I-RNTI). In one example, the UE ID is part of (or related to) the UE ID assigned by the RAN, e.g. indicted UE ID is the n least significant bits of the UE ID, or indicted UE ID is the n most significant bits of the UE ID, or indicated ID is UE ID % N, or indicated ID is ceiling (UE ID/N).

FIGS. 13A-E illustrate examples of fields related to a UE ID and SRS resource ID (and/or SRS resource set ID) in a message triggering SRS transmission according to embodiments of the present disclosure. The fields in FIGS. 13A-E are for illustration only and other embodiments can be used without departing from the scope of the present disclosure.

For example, the messages can be a DCI Format and/or a higher layer message as described in this disclosure. Other fields are not excluded from the messages of FIGS. 13A-E.

In one example, DCI Format includes 1 UE ID, for example as illustrated in FIG. 13A and FIG. 13C, wherein a UE-ID is as aforementioned. In one example, DCI format includes N UE-IDs, for example as illustrated in FIG. 13B, FIG. 13D and FIG. 13E, wherein a UE-ID is as aforementioned. In one example, N is defined in the system specifications, e.g., N=2 or N=3 or N=4, . . . . In one example, N is configured to the UE, for example, N can be in the system information e.g. SIB1 or configured by RRC signaling and/or MAC CE signaling and/or L1 control signaling. In one example, the DCI Format is a two-stage or two-part DCI Format, the first stage or part includes the number N of UE IDs, and the N UE IDs are included in the second stage or part.

In one example, SRS resource (or resource set) is configured by system information. In one example, M SRS resources (or resource sets) are configured by system information, wherein a UE can determine the SRS resources (or resource sets) to use when triggered to transmit SRS (e.g., by indication in the DCI Format). In one example, M SRS resources or resource sets are configured by system information, wherein a UE can determine the SRS resource or resource set to use when triggered to transmit SRS. In one example, SRS resource ID (and/or SRS resource set ID) is included in the configuration of the SRS resource or SRS resource set. In one example, the SRS resource ID is determined based on the order of the SRS resource (or SRS resource sets) in the list of M SRS resources (SRS resource sets). For a first SRS resource (or resource set) in the list has SRS resource (or resource set) ID 0 or SRS resource (or resource set) ID 1. A second SRS resource (or resource set) in the list has SRS resource (or resource set) ID 1 or SRS resource (or resource set) ID 2 respectively.

In one example, a SRS resource (or resource set) determination can be based on a mapping between UE-ID and the M configured SRS resources (or resource sets). In one example, a SRS resource (or resource set) determination can be based on a mapping between the resources used for the PDCCH reception providing the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources (or resource sets). In one example, a SRS resource (or resource set) determination can be based on a mapping between UE-ID and resources used for PDCCH reception providing the DCI Format as aforementioned, and the M configured SRS resources (or resource sets).

In one example, the DCI format includes a SRS resource (or resource set) ID as illustrated in FIG. 13C, FIG. 13D and FIG. 13E. In one example, a SRS resource (or resource set) ID is included for each UE ID for example as illustrated in FIG. 13C and FIG. 13C, wherein UE ID0 triggers SRS ID0, UE ID1 triggers SRS ID1, etc. In a variant example, DCI Format includes one SRS ID as illustrated in FIG. 13E. In one example of FIG. 13E, the SRS ID is for the UE ID0, the SRS ID for another UE ID can be determined based on the SRS ID and a rule, for example, UE ID1 can use SRS ID+1, UE ID2 can use SRS ID+2, etc. The rule can be a function of the SRS ID and the UE ID.

In one example, the CRC of the DCI Format is scrambled with a RNTI and the RNTI is associated with triggering SRS.

In one example, the DCI Format indicates the UE to trigger the SRS transmission. In one example, the DCI Format includes a bitmap, and there is mapping between a bit in the bitmap and the UE. In one example, this mapping is based on rule (e.g., derived based on the UE ID). In one example, this mapping is based on a network configuration. In one example, this mapping is based on a combination of a rule and network configuration. In one example, a UE is configured with a bit in the bitmap that corresponds to the UE.

In one example, the DCI Format indicated to the UE to trigger the SRS transmissions based on the time and/or frequency resources of the PDCCH providing the DCI Format, e.g., (e.g., starting) channel control elements (CCEs) or (e.g., starting) resource element groups (REGs) or (e.g., starting) resource blocks (RBs) or (e.g., starting) symbols or slots or subframes or frames, etc. In one example, this mapping is based on rule (e.g., derived based on the UE ID). In one example, this mapping is based on a network configuration. In one example, this mapping is based on a combination of a rule and network configuration. In one example, a UE is configured with the time and frequency resources of the DCI Format that correspond to the UE.

In one example, the DCI Format indicates to the UE to trigger the SRS transmissions based on the RNTI used to scramble the CRC of the DCI format. In one example, multiple RNTIs are configured for a DCI format triggering SRS. In one example, this mapping between RNTI and UE is based on a rule (e.g., derived based on the UE ID). In one example, this mapping between RNTI and UE is based on a network configuration. In one example, this mapping between RNTI and UE is based on a combination of a rule and network configuration. In one example, a UE is configured with a RNTI for SRS triggering that corresponds to the UE.

In one example, the DCI Format indicates to the UE to trigger the SRS based on one or more of bitmap and time/frequency resource for the PDCCH providing the DCI format and the RNTI for DCI Format as aforementioned.

In one example, the DCI Format triggering SRS transmission indicates to the UE to transmit the SRS transmission, and the SRS ID is determined. In one example, a determination can be based on a mapping between UE-ID and the M configured SRS resources (or resource sets). In one example, a determination can be based on a mapping between the resources used for the PDCCH providing the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources (or resource set). In one example, a determination can be based on a mapping between UE-ID and resources used for reception of the PDCCH providing the DCI Format as aforementioned, and the M configured SRS resources (or resource set).

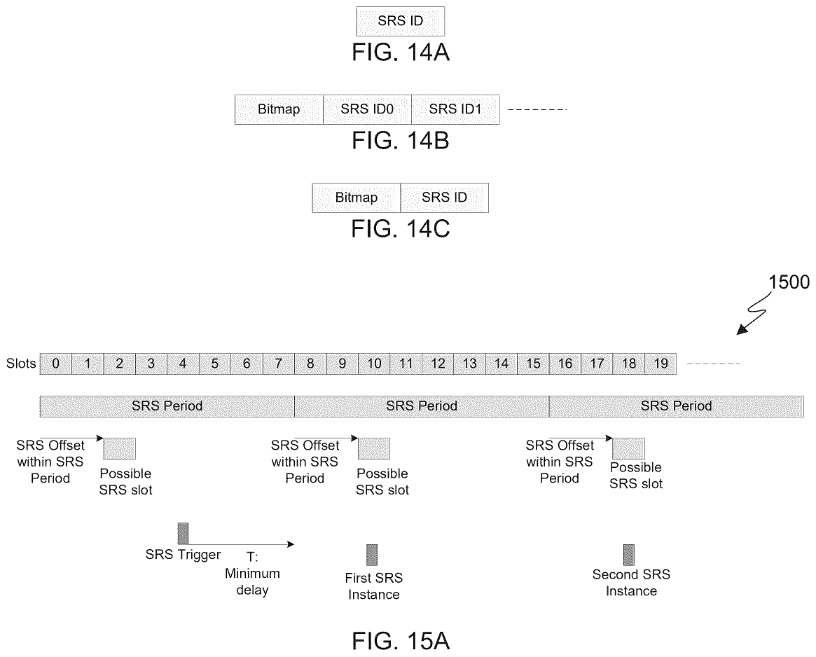

In one example, the DCI Format indicates to the UE to trigger the SRS transmission, and the SRS ID is indicated by information in the DCI Format for example as illustrated in FIG. 14A, FIG. 14B, and FIG. 14C.

FIGS. 14A-C illustrate examples of fields in a message triggering SRS transmission according to embodiments of the present disclosure. The messages in FIGS. 14A-C are for illustration only and other embodiments can be used without departing from the scope of the present disclosure.

In one example, in FIG. 14A, the UE to transmit SRS is indicated to the UE e.g., by the DCI Format (e.g., based on time and/or frequency resources a PDCCH providing the of DCI Format and/or RNTI of the DCI Format), and SRS ID of the M configured SRS resources is included in the DCI Format.

In one example, in FIG. 14B, the UE(s) is indicated to transmit SRS by a bit map in a DCI Format and optionally based on time and/or frequency resources of a PDCCH providing the DCI Format and/or the RNTI of the DCI Format SRS ID(s) of the M configured SRS resources (or resource set) are included in the DCI Format. For example, the first SRS ID corresponds to the first non-zero bit of the bitmap, the second SRS ID corresponds to the second non-zero bit of the bitmap, and so on. The number of SRS IDs included in the DCI format can be equal to the number of non-zero bits in the bitmap. In one example, padding is included to make the size of the DCI Format constant and independent of the number of non-zero bits in the bitmap. In one example, the DCI format is a two stage or two-part DCI format, in one example, the bitmap is included in the first stage or part, and the SRS resource (or resource set) IDs corresponding to non-zero bits of the bitmap are included in the second stage or part.

In one example, in FIG. 14C, the UE(s) is indicated to transmit SRS by a bit map in a DCI Format and optionally based on time and/or frequency resources of a PDCCH providing the DCI Format and/or the RNTI of the DCI Format SRS ID(s) of the M configured SRS resources (or resource set) are included in the DCI Format. A SRS resource (or resource set) ID is included in the bit map, and the resource (or resource set) ID for each UE transmitting SRS can be determined based on the order of corresponding non-zero bits and the SRS ID. For example, the UE corresponding to the first non-zero bit transmits SRS resource (or resource set) with SRS ID, the UE corresponding to the second non-zero bit transmits SRS resource (or resource set) with SRS ID+1, and so on. The rule can be a function of the SRS ID and the non-zero-bit position relative to other non-zero bits or in the bitmap.

In one example, the slot or subframe or frame used by a UE to transmit SRS resource (or resource set) can be based on configuration of the corresponding SRS (e.g., using system information).

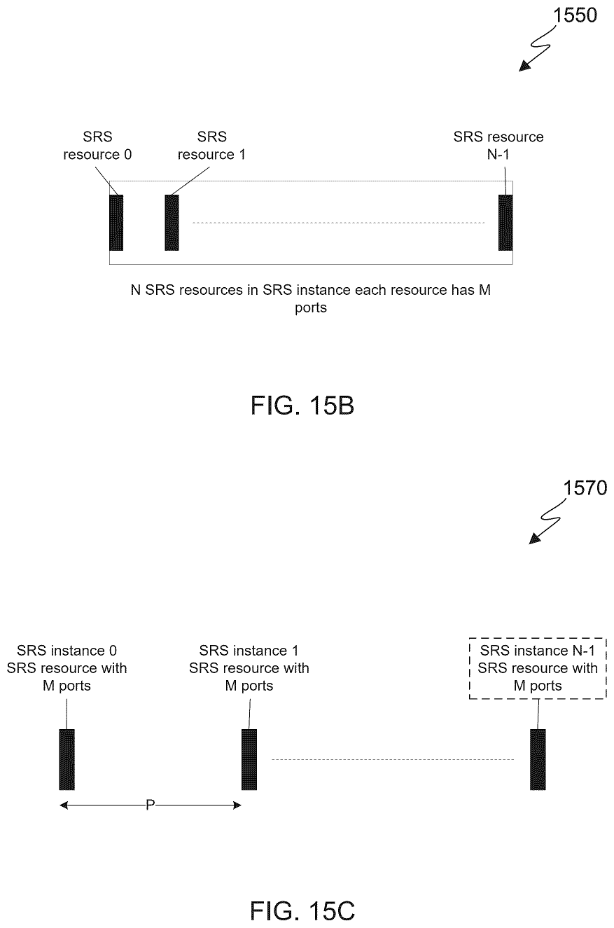

FIG. 15A illustrates an example of an SRS configuration 1500 according to embodiments of the present disclosure. The SRS configuration 1500 is for illustration only and other embodiments can be used without departing from the scope of the present disclosure.

In one example, the SRS resource can be transmitted by a UE a minimum time T from the end (or start) of a PDCCH reception providing the DCI Format triggering the SRS transmission or the start of end of the channel (e.g., PUCCH or PUSCH) carrying the acknowledgment to the DCI format. In one example, the slot or subframe or frame used by a UE to transmit SRS resource can be at or after a time T from the end (or start) of the PDCCH reception providing the DCI Format triggering the SRS transmission or at or after a time T from the end (or start) of the channel (e.g., PUCCH or PUSCH) carrying the acknowledgment to the DCI format. In one example, the slot or subframe or frame used by a UE to transmit SRS resource is that first slot or subframe or frame that starts at or after a time T from the end (or start) of a PDCCH reception providing the DCI Format triggering the SRS transmission and optionally based on an offset and a periodicity as illustrated in FIG. 15A. Wherein, the time T can be defined in the system specifications and/or configured or updated by network (e.g., using SIB signaling and/or RRC signaling and/or MAC CE signaling and/or L1 control signaling). In one example, the SRS transmission in FIG. 15A, can be one-shot, e.g., one instance of SRS, with a time T from the trigger of SRS as aforementioned. In one example, the SRS transmission in FIG. 15A, can be N-shots, e.g., N-instances of SRS, with a periodicity P between each two-consecutive instances, and a minimum time T from the trigger, for the first instance, as aforementioned. In one example, the SRS transmission corresponds to the resources of the triggered SRS resource set(s).

As illustrated in FIG. 15A, the SRS configuration 1500 includes where a SRS period is configured (e.g., 8 slots) and a SRS offset within the SRS period for the SRS slots is configured (e.g., 2 slots). The configuration of the SRS offset, and SRS period can be by SIB configuration or by RRC configuration. The SRS period and the SRS offset determine the potential (possible) SRS slots. A UE receives a SRS trigger, after a delay T from the SRS trigger the SRS can be transmitted. The UE transmits the first instance of SRS in the earliest (first) potential SRS slot (as determined by the period and offset) occurring after a time T (when SRS is periodic or semi-persistent) from the SRS trigger as illustrated in FIG. 15A. In FIG. 15A, SRS is transmitted in two instances.

FIGS. 15B-C illustrate examples of SRS transmissions 1550 and 1570 according to embodiments of the present disclosure. The SRS transmissions 1550 and 1570 are for illustration only and other embodiments can be used without departing from the scope of the present disclosure.

In one example, a UE with SRS antenna switching capability xTyR, transmits N SRS resources per instance as illustrated in FIG. 15B, each SRS resource has M ports. SRS resource has index i, where i=0, 1, . . . , N−1. In one example, each SRS resource of the N SRS resources corresponds to a different symbol within the same slot, or across multiple slots, or SRS resources of an SRS resource set. In example,

$$N = \frac{y}{x} .$$

In one example, M=x. in one example, the M ports of the SRS resource i are different from the M ports of SRS resource j, where, i=0, 1, . . . , N−1, j=0, 1, . . . . N−1, and i≠j. In one example, a UE with SRS antenna switching capability xTyR, transmits 1 SRS resources per instance across N instances, as illustrated in FIG. 15C, each SRS resource has M ports. SRS resource has index i, where i=0, 1, . . . , N−1. In example,

$$N = \frac{y}{x} .$$

In one example, M=x. In one example, the M ports of the SRS resource i are different from the M ports of SRS resource j, where, i=0, 1, . . . , N−1, j=0, 1, . . . . N−1, and i≠j. In one example, the SRS repeats for N instances. In one example, the SRS can repeat for more than N instances and the N SRS resources cycle periodically through the SRS instances. In one example, SRS instance k is used for SRS resource i, where i=k % N, and the first SRS instance after the trigger has k=0.

In one example, a UE can indicate a codepoint corresponding to a set of SRS antenna switching capabilities, e.g., {Tx1Ry1, Tx2Ry2, . . . . TxnRyn}, wherein

$$\frac{y 1}{x 1} = \frac{y 2}{x 2} … = \frac{yn}{xn} .$$

The UE transmits N SRS resources per instance, where

$$N = \frac{y 1}{x 1} .$$

In one example, the number of SRS ports is determined based on xi of the UE SRS antenna switching capability supported by the UE. In one example, the number of SRS ports, M, is determined based on M=max (x1, x2, . . . , xn). In one example, the number of SRS ports, M, is determined based on M=min (x1, x2, . . . , xn).

In one example, the SRS is triggered by a message (e.g., higher layer message) in a PDSCH. In one example, this message is a SIB message. In one example, this message is a RRC message. In one example, this message is a MAC CE message. In one example, the PDSCH providing the message is scheduled by a corresponding DCI Format. In one example, the message part of a RACH procedure as described herein.

In one example, the higher layer message includes a UE ID. In one example, the UE ID is a UE ID assigned or allocated by the core network, for example S-Temporary Mobile Subscription Identifier (S-TMSI or NG 5G S-TMSI). In one example, the UE ID is part of (or related to) the UE ID assigned by the core network, e.g. indicted UE ID is the n least significant bits of the UE ID, or indicted UE ID is the n most significant bits of the UE ID, or indicated ID is UE ID % N, or indicated ID is ceiling (UE ID/N). Where, % is the modulus function, where x % y is the remainder of dividing x by y. In one example, the UE ID is a UE ID assigned or allocated by the radio access network (RAN). In one example, UE ID is the I-RNTI. In one example, the UE-ID is a short I-RNTI (e.g., 24 bits of the I-RNTI). In one example, the UE ID is a long I-RNTI (e.g., 40 bits I-RNTI). In one example, the UE ID is part of (or related to) the UE ID assigned by the RAN, e.g. indicted UE ID is the n least significant bits of the UE ID, or indicted UE ID is the n most significant bits of the UE ID, or indicated ID is UE ID % N, or indicated ID is ceiling (UE ID/N).

In one example, the higher layer message includes 1 UE ID, for example as illustrated in FIG. 13A and FIG. 13C, wherein a UE-ID is as aforementioned. In a variant example, the signaling of the UE ID is split between the DCI Format and the higher layer message. In one example, the higher layer message includes N UE-IDs, for example as illustrated in FIG. 13B, FIG. 13D and FIG. 13E, wherein a UE-ID is as aforementioned. In one example, Nis defined in the system specifications, e.g., N=2 or N=3 or N=4, . . . . In one example, N is configured to the UE, for example, N can be in the system information e.g. SIB1 or configured by RRC signaling and/or MAC CE signaling and/or L1 control signaling. In a variant example, the signaling of the N UE IDs is split between the DCI Format and the higher layer message. In one example, the DCI format includes one part of the UE ID for each of the N UE IDs, and the higher layer message includes a second part for each of the N UE IDs. In one example, the DCI format includes one part of the UE ID that is common for the N UE IDs, and the higher layer message includes a second part for each of the N UE IDs. In one example, the DCI Format includes the number N of UE IDs, and the N UE IDs are included the message scheduled by the DCI Format.

In one example, SRS resource (or resource set) is configured by system information. In one example, M SRS resources (or resource sets) are configured by system information, wherein a UE can determine the SRS resources (or resource sets) to use when triggered to transmit SRS (e.g., by indication in the DCI Format). In one example, M SRS resources (or resource sets) are configured by system information, wherein a UE can determine the SRS resources (or resource sets) to use when triggered to transmit SRS. In one example, SRS resource ID is included in the configuration of the SRS resource (or resource set). In one example, the SRS resource (or resource set) ID is determined based on the order of the SRS resource (or resource set) in the list of M SRS resources (or resource sets). For a first SRS resource (or resource set) in the list has SRS resource (or resource set) ID 0 or SRS resource (or resource set) ID 1. A second SRS resource (or resource set) in the list has SRS resource (or resource set) ID 1 or SRS resource (or resource set) ID 2 respectively.

In one example, a SRS resource (or resource set) determination can be based on a mapping between UE-ID and the M configured SRS resources (or resource sets). In one example, a SRS resource (or resource set) determination can be based on a mapping between the resources used for the higher layer message and/or the PDCCH providing the corresponding DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources (or resource sets). In one example, a SRS resource (or resource set) determination can be based on a mapping between UE-ID and resources used for higher layer message and/or the PDCC providing the corresponding DCI Format as aforementioned, and the M configured SRS resources (or resource set).

In one example, the higher layer message and/or the corresponding DCI Format includes a SRS resource (or resource set) ID as illustrated in FIG. 13C, FIG. 13D, and FIG. 13E. In one example, a SRS resource (or resource set) ID is included for each UE ID for example as illustrated in FIG. 13C and FIG. 13D, wherein UE ID0 triggers SRS ID0, UE ID1 triggers SRS ID1, etc. In a variant example, higher layer message and/or the corresponding DCI Format includes one SRS ID as illustrated in FIG. 13E. In one example of FIG. 13E, the SRS ID is for the UE ID0, the SRS ID for another UE ID can be determined based on the SRS ID and a rule, for example, UE ID1 can use SRS ID+1, UE ID2 can use SRS ID+2, etc. The rule can be a function of the SRS ID and the UE ID.

In one example, the CRC of the higher layer message and/or the corresponding DCI Format is scrambled with a RNTI and the RNTI is associated with triggering SRS.

In one example, the higher layer message and/or the corresponding DCI Format indicates to the UE to trigger the SRS transmission. In one example, the higher layer message and/or the corresponding DCI Format includes a bitmap, and there is mapping between a bit in the bitmap and the UE. In one example, this mapping is based on rule (e.g., derived based on the UE ID). In one example, this mapping is based on a network configuration. In one example, this mapping is based on a combination of a rule and network configuration. In one example, a UE is configured with a bit in the bitmap that corresponds to the UE.

In one example, the higher layer message and/or the corresponding DCI Format indicates to the UE to trigger the SRS transmission based on the time and/or frequency resources of the PDCCH providing the DCI Format, e.g., (e.g., starting) channel control elements (CCEs) or (e.g., starting) resource element groups (REGs) or (e.g., starting) resource blocks (RBs) or (e.g., starting) symbols or slots or subframes or frames, etc. In one example, this mapping is based on rule (e.g., derived based on the UE ID). In one example, this mapping is based on a network configuration. In one example, this mapping is based on a combination of a rule and network configuration. In one example, a UE is configured with the time and frequency resources of the higher layer message and/or the corresponding DCI Format that correspond to the UE.

In one example, the higher layer message and/or the corresponding DCI Format indicates to the UE to trigger the SRS transmission based on the RNTI used to scramble the CRC of the DCI format. In one example, multiple RNTIs are configured for a DCI format triggering SRS and/or a higher layer message. In one example, this mapping between RNTI and UE is based on a rule (e.g., derived based on the UE ID). In one example, this mapping between RNTI and UE is based on a network configuration. In one example, this mapping between RNTI and UE is based on a combination of a rule and network configuration. In one example, a UE is configured with a RNTI for SRS triggering that corresponds to the UE.

In one example, the higher layer message and/or the PDCCH providing the corresponding DCI Format indicates to the UE to trigger the SRS transmission based on one or more of bitmap and time/frequency resource for higher layer message and/or the PDCCH providing the corresponding DCI format and the RNTI for higher layer message and/or the corresponding DCI Format as aforementioned.

In one example, the higher layer message and/or the corresponding DCI Format trigger SRS transmission indicates to the UE to transmit the SRS transmission, and the SRS ID is determined from other parameters. In one example, the determination can be based on a mapping between UE-ID and the M configured SRS resources (or resource set). In one example, the determination can be based on a mapping between the resources used for the higher layer message and/or the corresponding PDCCH that provides the DCI Format (e.g., time and/or frequency resources, e.g., (e.g., starting) channel control elements (CCEs) or (e.g., starting) resource element groups (REGs) or (e.g., starting) resource blocks (RBs) or (e.g., starting) symbols or slots or subframes or frames etc.) and the M configured SRS resources (or resource set). In one example, the indication can be based on a mapping between UE-ID and resources used for the PDCCH providing the DCI Format as aforementioned, and the M configured SRS resources (or resource set).

In one example, the higher layer message and/or the corresponding PDCCH/DCI Format indicates to the UE to trigger the SRS transmission, and the SRS ID is indicated in the higher layer message and/or the corresponding PDCCH/DCI Format for example as illustrated in FIG. 14A, FIG. 14B, and FIG. 14C.

In one example, in FIG. 14A, the UE is indicated to transmit SRS by the higher layer message and/or the corresponding PDCCH/DCI Format (e.g., based on time and/or frequency resources of higher layer message and/or the corresponding PDCCH/DCI Format and/or RNTI of higher layer message and/or the corresponding DCI Format), and SRS ID of the M configured SRS resources (or resource set) is included in the higher layer message and/or the corresponding DCI Format.

In one example, in FIG. 14B, the UE(s) to transmit SRS are determined by bit map in the higher layer message and/or the corresponding DCI Format and optionally based on time and/or frequency resources of higher layer message and/or the corresponding PDCCH/DCI Format and/or RNTI of higher layer message and/or the corresponding DCI Format, and SRS ID(s) of the M configured SRS resources (or resource set) are included in the higher layer message and/or the corresponding DCI Format. For example, the first SRS ID corresponds to the first non-zero bit of the bitmap, the second SRS ID corresponds to the second non-zero bit of the bitmap, and so on. The number of SRS IDs included in higher layer message and/or the corresponding DCI Format can equal to the number of non-zero bits in the bitmap. In one example, padding is included to make the size of the DCI Format associated with the higher layer message constant and independent of the number of non-zero bits in the bitmap. In one example, the DCI format is a two stage or two-part DCI format, in one example, the bitmap is included in the first stage or part, and the SRS resource IDs corresponding to non-zero bits of the bitmap are included in the second stage or part and/or the higher layer message.

In one example, in FIG. 14C, the UE(s) to transmit SRS are determined by bit map in the higher layer message and/or the corresponding DCI Format and optionally based on time and/or frequency resources of higher layer message and/or the corresponding PDCCH/DCI Format and/or RNTI of higher layer message and/or the corresponding DCI Format, and SRS ID(s) of the M configured SRS resources (or resource set) are included in the higher layer message and/or the corresponding DCI Format. A SRS resource (or resource set) ID is included in the bit map, the resource (or resource set) ID for each UE transmitting SRS can be determined based on the order of corresponding non-zero bit and the SRS ID. For example, the UE corresponding to the first non-zero bit transmits SRS resource (or resource set) with SRS ID, the UE corresponding to the second non-zero bit transmits SRS resource (or resource set) with SRS ID+1, and so on. The rule can be a function of the SRS ID and the non-zero-bit position relative to other non-zero bits or in the bitmap.

In one example, the slot or subframe or frame used by a UE to transmit SRS resource (or resource set) can be based on configuration of the corresponding SRS (e.g., using system information).

In one example, the SRS resource can be transmitted at or after a time T from the end (or start) of a PDSCH reception providing the higher layer message or from the end (or start) of the PDCCH reception providing the corresponding DCI Format triggering the SRS transmission. In one example, the slot or subframe or frame used to transmit SRS resource can be at least a time T after the end (or start) of the PDSCH reception providing the higher layer message or of the PDCCH reception providing the corresponding DCI Format triggering the SRS transmission. In one example, the slot or subframe or frame used to transmit SRS resource is that first slot or subframe or frame that starts after a time T from the end (or start) of the PDSCH reception providing the higher layer message or from the end (or start) of the PDCCH reception providing the corresponding DCI Format triggering the SRS transmission and optionally based on an offset and a periodicity as illustrated in FIG. 15A. Wherein, the time T can be defined in the system specifications and/or configured or updated by network (e.g., using SIB signaling and/or RRC signaling and/or MAC CE signaling and/or L1 control signaling). In one example, the SRS transmission corresponds to the resources of the triggered SRS resource set(s).

In one example, the SRS resource can be transmitted at or after a time T after an end (or start) of a PUCCH or PUSCH transmission with acknowledgment information corresponding to the higher layer message triggering the SRS transmission. In one example, the slot or subframe or frame used to transmit SRS resource can be at or after a time T after the end (or start) of a PUCCH or PUSCH transmission with an acknowledgment information corresponding to the higher layer message triggering the SRS transmission. In one example, the slot or subframe or frame used to transmit SRS resource is that first slot or subframe or frame that starts at or after a time T after the end (or start) of a PUCCH or PUSCH transmission with an acknowledgment information corresponding to the higher layer message triggering the SRS transmission and optionally based on an offset and a periodicity as illustrated in FIG. 15A, where the SRS trigger is replaced by acknowledgment to SRS trigger. Wherein, the time T can be defined in the system specifications and/or configured or updated by network (e.g., using SIB signaling and/or RRC signaling and/or MAC CE signaling and/or L1 control signaling). In one example, the SRS transmission corresponds to the resources of the triggered SRS resource set(s).

In one example, there is no acknowledgment information for the higher layer message, and the transmission of SRS can be considered as acknowledgment information. For example, if the network doesn't receive or detect SRS, the higher layer message can be retransmitted.

In a variant of the aforementioned examples, the SRS configuration parameters (or a subset of them) for one or more SRS resources can be included in the higher layer message and/or the corresponding DCI format instead of or in addition to the SRS ID for the one or more SRS resources (or SRS resources). Wherein the configuration for the SRS resource (or SRS resource) can be as aforementioned.

Various embodiments of the present disclosure provide for SRS triggering associated with random access procedure. In the following examples, as described, a UE can indicate the support of early SRS by the preamble and/or RO used for the random access procedure. In one example a set of preambles and/or ROs are configured for the UE to indicate early SRS (UE can randomly select a preamble/RO from the set for early SRS support indication). The set of preambles and/or ROs can be per-SS/PBCH block, or can be common across SS/PBCH blocks.

In one example, preambles within existing RO configurations can be used to indicate that the UE supports early SRS (e.g., group g₁), legacy preambles are used to indicate that the UE doesn't support early SRS (e.g., group g₀). In one example, new ROs can be used to indicate that the UE supports early SRS, e.g., preambles in new ROs can be used to indicate that the UE supports early SRS (e.g., group g₁), legacy preambles (e.g., in legacy ROs) are used to indicate that the UE doesn't support early SRS (e.g., group g₀).

A UE can be configured with a set of preambles in group g₁ for indicating support of early SRS. A UE can be configured with a set of preambles in group g₀ (e.g., legacy preambles) for indicating non-support of early SRS, or UE doesn't prefer transmitting early SRS. In one example, a UE randomly selects a preamble from group g₁, if the UE supports early SRS (or if the UE supports and desires to transmit early SRS). A network/gNB receiving a preamble in group g₁ can indicate to or configure the UE, in a subsequent message or messages to transmit early SRS as described in this disclosure. In one example, a UE randomly selects a preamble from group g₀, if the UE doesn't support early SRS (or if the doesn't desire to transmit early SRS). A network/gNB receiving a preamble in group g₀ is expected not to indicate or configure the UE to transmit early SRS.

In one example, the preambles and/or ROs in group g₁ are configured for each SS/PBCH block.

In one example, the preambles and/or ROs in group g₁ are configured commonly for all SS/PBCH blocks.

In a variant of the above examples, a set of preambles and/or ROs can be configured for group g₀, e.g., separate from the legacy preambles and/or ROs. In one example, the preambles and/or ROs in group g⁰ are configured for each SS/PBCH block. In one example, the preambles and/or ROs in group g₀ are configured commonly for all SS/PBCH blocks.

In the following examples, as described, a UE can indicate its SRS antenna switching xTyR capability for early SRS based on the preamble and/or RO used for the random access procedure. In one example a first set of preambles and/or ROs are configured for the UE to indicate support of a first xTyR capability, a second set of preambles and/or ROs are configured for the UE to indicate support of a second xTyR capability, . . . , an Nth set of preambles and/or ROs are configured for the UE to indicate support of an Nth xTyR capability. Wherein, the UE can randomly select a preamble from a set, and the set corresponds to the UE's SRS antenna switching capability (or early SRS antenna switching capability). In one example, the selection of a preamble from any of the N sets indicates to the network that the UE supports early SRS (or supports and desires to transmit early SRS). In one example, the network upon receiving a preamble associated with an ith group, determines that the UE can transmit an SRS resource(s) corresponding to the ith group corresponding to a SRS antenna switching capability xTyR associated with the ith group.

In one example, the SRS antenna switching capability xTyR is indicated by a combination of signaling in preamble/RO (e.g., based on the preamble/TO group), and Msg3 or PUSCH MsgA.

In one example, an RO (e.g., per SS/PBCH block or across all SS/PBCH blocks) is configured for indicating the SRS antenna switching xTyR capability. In one example, the RO has M, e.g., 64 preambles, and the M preambles are split among N groups of preambles. In one example, an RO has M preambles per SSB, and the M preambles are split among N groups of preambles. In one example, the RO has M preambles per SSB per preamble group (group A and group B wherein group A and group B indicates different Msg3/MsgA size), and the M preambles are split among N groups of preambles.

In one example, N=6, and the xTyR capability indicated by a preamble (e.g., according to the set of the preamble) can be one of {‘t1r2’ for 1T2R, ‘t2r4’ for 2T4R, ‘t1r4’ for 1T4R, ‘t1r1’ for 1T=1R, ‘t2r2’ for 2T=2R, or ‘t4r4’ for 4T=4R}.

In one example, N=7, and the xTyR capability indicated by a preamble can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, or ‘t4r4’ for 4T=4R}.

In one example, N=7, and the xTyR capability indicated by a preamble (e.g., according to the set of the preamble) can be one of {‘t1r2’ for 1T2R, ‘t2r4’ for 2T4R, ‘t1r4’ for 1T4R, ‘t1r1’ for 1T=1R, ‘t2r2’ for 2T=2R, ‘t4r4’ for 4T=4R, or not supported}.

In one example, N=8, and the xTyR capability indicated by a preamble (e.g., according to the set of the preamble) can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=IR, ‘t2r2’ for 2T=2R, ‘t4r4’ for 4T=4R, or not supported}.

In one example, N=3, and the xTyR capability indicated by a preamble (e.g., according to the set of the preamble) can be one of {‘t1r2’ for 1T2R, ‘t1r1’ for 1T=1R, or ‘t2r2’ for 2T=2R}.

In one example, N=3, and the xTyR capability indicated by a preamble (e.g., according to the set of the preamble) can be one of {‘t1r1’ for 1T=1R, ‘t1r2’ for 1T2R, or ‘t1r4’ for 1T4R}.

In one example, N=3, and the xTyR capability indicated by a preamble (e.g., according to the set of the preamble) can be one of {1T4R, 1T2R/2T4R, 1T=1R/2T=2R/4T=4R}. In one example, the number of SRS resources transmitted is one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R. In one example, the number of ports is indicated in Msg3 or MsgA PUSCH.

In one example, N=11, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R}.

In one example, N=12, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or not supported}.

In one example, N=6, and the xTyR capability indicated by a preamble (e.g., according to the set of the preamble) can be one of {1T8R, 1T6R, 1T4R/2T8R, 2T6R, 1T2R/2T4R/4T8R, 1T=1R/2T=2R/4T=4R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R. In one example, the number of ports is indicated in Msg3 or MsgA PUSCH.

In one example, N=12, and the xTyR capability indicated by a preamble (e.g., according to the set of the preamble) can be one of {‘t1r1’ for 1T=IR, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=13, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=13, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=14, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the xTyR capability indicated by a preamble (e.g., according to the set of the preamble) can be one of {1T8R, 1T6R, 1T4R/2T8R, 2T6R, 1T2R/2T4R/4T8R, 1T=1R/2T=2R/4T=4R/8T8R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R. In one example, the number of ports is indicated in Msg3 or MsgA PUSCH.

In one example, N=14, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=15, and the xTyR capability indicated by a preamble (e.g., according to the set of the preamble) can be one of {‘t1r1’ for 1T=IR, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=15, and the xTyR capability indicated by a preamble (e.g., according to the set of the preamble) can be one of {‘t1r1’ for 1T=IR, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=16, and the xTyR capability indicated by a preamble (e.g., according to the set of the preamble) can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the xTyR capability indicated by a preamble (e.g., according to the set of the preamble) can be one of {1T8R, 1T6R, 1T4R/2T8R, 2T6R, 1T2R/2T4R/3T6R/4T8R, 1T=1R/2T=2R/3T=3R/4T=4R/8T8R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 3 ports for 3T6R and 3T=3R, 4 ports for 4T8R and 4T=4R and 8 ports for 8T8R. In one example, the number of ports is indicated in Msg3 or MsgA PUSCH.

In one example, N=5, and the xTyR capability indicated by a preamble (e.g., according to the set of the preamble) can be one of {1T8R, 1T6R, 1T4R, 1T2R, or 1T=1R}.

In one example, N=6, and the xTyR capability indicated by a preamble (e.g., according to the set of the preamble) can be one of {1T8R, 1T6R, 1T4R, 1T2R, 1T=1R or not supported}.

In one example, N=4, and the xTyR capability indicated by a preamble (e.g., according to the set of the preamble) can be one of {1T8R, 1T4R, 1T2R, or 1T=1R}.

In one example, N=5, and the xTyR capability indicated by a preamble (e.g., according to the set of the preamble) can be one of {1T8R, 1T4R, 1T2R, 1T=1R or not supported}.

In a variant of the aforementioned examples, there are N codepoints indicated by the preamble and/or RO, wherein each code-point can be a subset of {1T=IR, 1T2R, 1T4R, 1T6R, 1T8R, 2T=2R, 2T/4R, 2T/6R, 2T/8R, 3T=3R, 3T/6R, 4T=4R, 4T8R, 8T8R}. In a further example, an element of the subset is indicated by Msg3 or MsgA PUSCH.

In one example, configuration of the number of preamble groups for indication of SRS antenna switching capability, the preambles and/or ROs associated with each group (per SS/PBCH block or across SS/PBCH blocks), and xTyR capability (or set of capabilities) associated with each group can be configured and/or updated by SIB and/or RRC and/or MAC CE and/or L1 control (e.g., DCI Format) signaling.

In one example, for indication of N SRS antenna switching capability codepoints (or N SRS antenna switching capabilities), a set of preambles and/or ROs is configured for each codepoint of the N codepoints (or for each SRS antenna switching capability of the N SRS antenna switching capabilities). Each set of preambles and/or ROs can be per-SS/PBCH block, or can be common across SS/PBCH blocks.

In one example, M preambles (e.g., each preamble can be associated with index j=0, . . . , M−1) in one or more ROs (or M preambles per SSB in a RO or M preambles per SSB per preamble group (group A and group B wherein group A and group B indicates different Msg3/MsgA size) in a RO) are allocated for early SRS indication, the M preambles are divided into N groups (e.g., each group can have index i=0, 1, . . . , N−1) of preambles, for indication of N SRS antenna switching capability codepoints (or N SRS antenna switching capabilities). In one example, M is a multiple of N, and each group i, wherein i=0, 1, . . . , N−1 has M/N preambles. In one example, the preambles in group i can have index

$$j = i * \frac{M}{N} + k , where k = 0 , 1 , … , \frac{M}{N} - 1 .$$

In one example, the number of preambles per group is

$$⌊ \frac{M}{N} ⌋ .$$

In one example, the preambles in group i can have index

$$j = i * ⌊ \frac{M}{N} ⌋ + k , where k = 0 , 1 , … , ⌊ \frac{M}{N} ⌋ - 1.$$

In one example, the number of preambles per group is

$$⌈ \frac{M}{N} ⌉$$

for group i, if i< (M % N), and

$$⌊ \frac{M}{N} ⌋$$

for group i, if i≥(M % N), where % is the modulo operator, that is the remainder of M divided by N. In one example, the preambles in group i, for i<(M % N), can have index

$$j = i * ⌈ \frac{M}{N} ⌉ + k ,$$

$$where k = 0 , 1 , … , ⌈ \frac{M}{N} ⌉ - 1 .$$

In one example, the preambles in group i, for i≥(M % N), can have index

$$j = ( M \% N ) + i * ⌊ \frac{M}{N} ⌋ + k , where k = 0 , 1 , … , ⌊ \frac{M}{N} ⌋ - 1.$$

In the following examples, as described, a UE can indicate the support of early SRS and/or the UE's SRS antenna switching xTyR capability for early SRS in Msg3 or MsgA PUSCH. In one example, the UE is configured with “groupBconfigured” random access preambles for group B. In one example, the Msg3 or MsgA PUSCH payload size when the UE transmits random access preamble for group B is larger than the Msg3 or MsgA PUSCH payload size when the UE transmits random access preamble for group A. In one example, the network allocates time and frequency resources and MCS for a payload size of RACH Msg3 or MsgA PUSCH that is large enough for the UE to report UE's early SRS capability and/or the UE's SRS antenna switching xTyR capability for early SRS.

In one example, UE reports in RACH Msg3 or MsgA PUSCH support or not support of early SRS. For example, a one-bit flag can indicate early SRS is not supported (e.g., value 0), or early SRS is supported (e.g., value 1). In a variant example, a one-bit flag can indicate early SRS is not supported (e.g., value 1), or early SRS is supported (e.g., value 0).

In one example, UE reports in RACH Msg3 or MsgA PUSCH UE's SRS antenna switching xTyR capability or UE does not support early SRS.
In one example, the UE reports in RACH Msg3 or MsgA PUSCH one of {‘t1r2’ for 1T2R, ‘t2r4’ for 2T4R, ‘t1r4’ for 1T4R, ‘t1r1’ for 1T=IR, ‘t2r2’ for 2T=2R, ‘t4r4’ for 4T=4R, or not early SRS not supported}
In one example, the UE reports in RACH Msg3 or MsgA PUSCH one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, ‘t4r4’ for 4T=4R, or early SRS not supported}.
In one example, the UE reports in RACH Msg3 or MsgA PUSCH one of {‘t1r2’ for 1T2R, ‘t1r1’ for 1T=1R, ‘t2r2’ for 2T=2R, or early SRS not supported}
In one example, the UE reports in RACH Msg3 or MsgA PUSCH one of {‘t1r1’ for 1T=IR, ‘t1r2’ for 1T2R, ‘t1r4’ for 1T4R, or early SRS not supported}
In one example, the UE reports in RACH Msg3 or MsgA PUSCH one of {1T4R, 1T2R/2T4R, 1T=1R/2T=2R/4T=4R, or early SRS not supported}. In one example, the number of SRS resources transmitted is one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R.
In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or early SRS not supported}
In one example, the UE reports in RACH Msg3 or MsgA PUSCH one of {1T8R, 1T6R, 1T4R/2T8R, 2T6R, 1T2R/2T4R/4T8R, 1T=1R/2T=2R/4T=4R, or early SRS not supported}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R.
In one example, the UE reports in RACH Msg3 or MsgA PUSCH one of ‘t1r1’ for 1T=IR, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or early SRS not supported}.
In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or early SRS not supported}
In one example, the UE reports in RACH Msg3 or MsgA PUSCH one of {1T8R, 1T6R, 1T4R/2T8R, 2T6R, 1T2R/2T4R/4T8R, 1T=1R/2T=2R/4T=4R/8T8R, or early SRS not supported}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R.
In one example, the UE reports in RACH Msg3 or MsgA PUSCH one of {‘t1r1’ for 1T=IR, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or early SRS not supported}.
In one example, the UE reports in RACH Msg3 or MsgA PUSCH one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or early SRS not supported}.
In one example, the UE reports in RACH Msg3 or MsgA PUSCH one of {1T8R, 1T6R, 1T4R/2T8R, 2T6R, 1T2R/2T4R/3T6R/4T8R, 1T=1R/2T=2R/3T=3R/4T=4R/8T8R, or early SRS not supported}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=IR, 2 ports for 2T8R, 2T6R, 2T4R and 2T=2R, 3 ports for 3T6R and 3T=3R, 4 ports for 4T8R and 4T=4R and 8 ports for 8T8R.
In one example, the UE reports in RACH Msg3 or MsgA PUSCH one of {1T8R, 1T6R, 1T4R, 1T2R, 1T=1R or early SRS not supported}.
In one example, the UE reports in RACH Msg3 or MsgA PUSCH one of {1T8R, 1T4R, 1T2R, 1T=1R or early SRS not supported}.
In one example, the UE reports in RACH Msg3 or MsgA PUSCH one of {1T=1R, 1T2R, 1T4R, 1T6R, 1T8R, 2T=2R, 2T/4R, 2T/6R, 2T/8R, 3T=3R, 3T/6R, 4T=4R, 4T8R, 8T8R, or early SRS not supported}.
In a variant of the aforementioned examples, “early SRS not supported” is not included in corresponding sets.

In the following examples, as described, a UE can indicate the support of early SRS by the preamble and/or RO used for the random access procedure, and the UE can indicate the SRS antenna switching xTyR capability for early SRS in Msg3 or MsgA PUSCH. In one example a set of preambles and/or ROs are configured for the UE to indicate early SRS (UE can randomly select a preamble/RO from the set for early SRS support indication), as aforementioned. The set of preambles and/or ROs can be per-SS/PBCH block, or can be common across SS/PBCH blocks.

In one example, the Msg3 or MsgA PUSCH payload size when the UE transmits random access preamble indicating support of early SRS, is larger than the Msg3 or MsgA PUSCH payload size when the UE transmits random access preamble that doesn't indicate support of early SRS (e.g., legacy preamble). In one example, the network allocates time and frequency resources and MCS for a payload size of RACH Msg3 or MsgA PUSCH that is large enough for the UE to report UE's early SRS capability and/or the UE's SRS antenna switching xTyR capability for early SRS.

In one example, UE reports in RACH Msg3 or MsgA PUSCH UE's SRS antenna switching xTyR capability. In one example, UE reports that it does not support early SRS.
In one example, the UE reports in RACH Msg3 or MsgA PUSCH one of {‘t1r2’ for 1T2R, ‘t2r4’ for 2T4R, ‘t1r4’ for 1T4R, ‘t1r1’ for 1T=1R, ‘t2r2’ for 2T=2R, or ‘t4r4’ for 4T=4R}
In one example, the UE reports in RACH Msg3 or MsgA PUSCH one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=IR, ‘t2r2’ for 2T=2R, or ‘t4r4’ for 4T=4R}.
In one example, the UE reports in RACH Msg3 or MsgA PUSCH one of {‘t1r2’ for 1T2R, ‘t1r1’ for 1T=1R, or ‘t2r2’ for 2T=2R}
In one example, the UE reports in RACH Msg3 or MsgA PUSCH one of {‘t1r1’ for 1T=1R, ‘t1r2’ for 1T2R, or ‘t1r4’ for 1T4R}
In one example, the UE reports in RACH Msg3 or MsgA PUSCH one of {1T4R, 1T2R/2T4R, or 1T=1R/2T=2R/4T=4R}. In one example, the number of SRS resources transmitted is one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R.
In one example, the UE reports in RACH Msg3 or MsgA PUSCH one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, or ‘t1r8’ for 1T8R}
In one example, the UE reports in RACH Msg3 or MsgA PUSCH one of {1T8R, 1T6R, 1T4R/2T8R, 2T6R, 1T2R/2T4R/4T8R, or 1T=1R/2T=2R/4T=4R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R.
In one example, the UE reports in RACH Msg3 or MsgA PUSCH one of ‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or ‘t8r8’ for 8T8R}.
In one example, the UE reports in RACH Msg3 or MsgA PUSCH one of {‘t1r1’ for 1T=IR, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdm AndNoTdm’ for 8T8R}
In one example, the UE reports in RACH Msg3 or MsgA PUSCH one of {1T8R, 1T6R, 1T4R/2T8R, 2T6R, 1T2R/2T4R/4T8R, or 1T=1R/2T=2R/4T=4R/8T8R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R.
In one example, the UE reports in RACH Msg3 or MsgA PUSCH one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or ‘t8r8’ for 8T8R}.
In one example, the UE reports in RACH Msg3 or MsgA PUSCH one of {‘t1r1’ for 1T=IR, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.
In one example, the UE reports in RACH Msg3 or MsgA PUSCH one of {1T8R, 1T6R, 1T4R/2T8R, 2T6R, 1T2R/2T4R/3T6R/4T8R, or 1T=1R/2T=2R/3T=3R/4T=4R/8T8R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 3 ports for 3T6R and 3T=3R, 4 ports for 4T8R and 4T=4R and 8 ports for 8T8R.
In one example, the UE reports in RACH Msg3 or MsgA PUSCH one of {1T8R, 1T6R, 1T4R, 1T2R, or 1T=1R}.
In one example, the UE reports in RACH Msg3 or MsgA PUSCH one of {1T8R, 1T4R, 1T2R, or 1T=1R}.
In one example, the UE reports in RACH Msg3 or MsgA PUSCH one of {1T=1R, 1T2R, 1T4R, 1T6R, 1T8R, 2T=2R, 2T/4R, 2T/6R, 2T/8R, 3T=3R, 3T/6R, 4T=4R, 4T8R, or 8T8R}.

In the following examples, as described, a UE can indicate the support of early SRS and/or the UE's SRS antenna switching xTyR capability for early SRS in Msg3 or MsgA PUSCH. In one example, using a specific logical channel identifier (LCID)/extended LCID (eLCID) in MAC subheader of CCCH SDU included in Msg3/MsgA MAC PDU can indicate the support of early SRS and/or the UE's SRS antenna switching xTyR capability for early SRS.

In one example, a same preamble is used whether or not the UE supports early SRS. The early SRS capability can be indicated in Msg3 or MsgA PUSCH/MAC PDU. In one example a set of preambles and/or ROs are configured for the UE to indicate early SRS (UE can randomly select a preamble/RO from the set for early SRS support indication), as aforementioned. The set of preambles and/or ROs can be per-SS/PBCH block, or can be common across SS/PBCH blocks.

In one example, LCID/eLCID codepoint (e.g. in MAC subheader of CCCH SDU included in Msg3/MsgA) is configured for indicating the support of early SRS capability. In one example, the LCID/eLCID codepoint (e.g. in MAC subheader of CCCH SDU included in Msg3/MsgA) can be configured separately for different CCCH SDU sizes (e.g. 48 bits and 64 bits) for indicating the support of early SRS capability. In one example LCID/eLCID codepoint for indicating the support of early SRS capability can be separately configured for one or more of the following: a) UE which is neither redCap UE nor eRedCap UE, b) UE which is redCap UE, c) UE which is eRedCap UE, d) UE which is neither redCap UE nor eRedCap UE and supports PUCCH repetition of Msg4 HARQ-ACK, e) UE which is redCap UE and supports PUCCH repetition of Msg4 HARQ-ACK, f) UE which is eRedCap UE and supports PUCCH repetition of Msg4 HARQ-ACK.

In one example, N LCID/eLCIDs codepoints (e.g. in MAC subheader of CCCH SDU included in Msg3/MsgA) are configured for indicating the SRS antenna switching xTyR capability. In one example, N LCID/eLCIDs codepoints (e.g. in MAC subheader of CCCH SDU included in Msg3/MsgA) can be configured separately for different CCCH SDU sizes (e.g. 48 bits and 64 bits) for indicating the SRS antenna switching xTyR capability. In one example N LCID/eLCIDs codepoints for indicating the SRS antenna switching xTyR capability can be separately configured for one or more of the following: a) UE which is neither redCap UE nor eRedCap UE, b) UE which is redCap UE, c) UE which is eRedCap UE, d) UE which is neither redCap UE nor eRedCap UE and supports PUCCH repetition of Msg4 HARQ-ACK, e) UE which is redCap UE and supports PUCCH repetition of Msg4 HARQ-ACK, f) UE which is eRedCap UE and supports PUCCH repetition of Msg4 HARQ-ACK.

In one example, N=6, and the xTyR capability indicated by a LCID/eLCID codepoint can be one of {‘t1r2’ for 1T2R, ‘t2r4’ for 2T4R, ‘t1r4’ for 1T4R, ‘t1r1’ for 1T=IR, ‘t2r2’ for 2T=2R, or ‘t4r4’ for 4T=4R}.

In one example, N=7, and the xTyR capability indicated by a LCID/eLCID codepoint can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, or ‘t4r4’ for 4T=4R}.

In one example, N=7, and the xTyR capability indicated by a LCID/eLCID codepoint can be one of {‘t1r2’ for 1T2R, ‘t2r4’ for 2T4R, ‘t1r4’ for 1T4R, ‘t1r1’ for 1T=1R, ‘t2r2’ for 2T=2R, ‘t4r4’ for 4T=4R, or not supported}.

In one example, N=8, and the xTyR capability indicated by a LCID/eLCID codepoint can be one of {‘t1r2’ for 1T2R, ‘t2r4’ for 2T4R, ‘t1r4’ for 1T4R, ‘t1r4-t2r4’ for 1T4R/2T4R, ‘t1r1’ for 1T=1R, ‘t2r2’ for 2T=2R, ‘t4r4’ for 4T=4R, or not supported}.

In one example, N=3, and the xTyR capability indicated by a LCID/eLCID codepoint can be one of {‘t1r2’ for 1T2R, ‘t1r1’ for 1T=1R, or ‘t2r2’ for 2T=2R}.

In one example, N=3, and the xTyR capability indicated by LCID/eLCID codepoint can be one of {‘t1r1’ for 1T=1R, ‘t1r2’ for 1T2R, or ‘t1r4’ for 1T4R}.

In one example, N=3, and the xTyR capability indicated by a LCID/eLCID codepoint can be one of {1T4R, 1T2R/2T4R, 1T=1R/2T=2R/4T=4R}. In one example, the number of SRS resources transmitted is one of {4, 2, 1} respectively for each code point. In one example, the number of SRS ports per SRS resource is the number of Tx antennas, e.g., 1 port for 1T4R, 1T2R and 1T=1R, 2 ports for 2T4R and 2T=2R, and 4 ports for 4T=4R. In one example, the number of ports is indicated in Msg3 or MsgA PUSCH.

In one example, N=11, and the xTyR capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R}.

In one example, N=12, and the xTyR capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, or not supported}.

In one example, N=6, and the xTyR capability indicated by a LCID/eLCID codepoint can be one of {1T8R, 1T6R, 1T4R/2T8R, 2T6R, 1T2R/2T4R/4T8R, 1T=1R/2T=2R/4T=4R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, and 4 ports for 4T8R and 4T=4R. In one example, the number of ports is indicated in Msg3 or MsgA PUSCH.

In one example, N=12, and the xTyR capability indicated by a LCID/eLCID codepoint can be one of {‘t1r1’ for 1T=IR, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=13, and the xTyR capability indicated by a LCID/eLCID codepoint can be one of {‘t1r1’ for 1T=IR, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=13, and the xTyR capability indicated by a LCID/eLCID codepoint can be one of {‘t1r1’ for 1T=1R, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=14, and the xTyR capability indicated by a LCID/eLCID codepoint can be one of {‘t1r1’ for 1T=IR, ‘t2r2’ for 2T=2R, ‘t1r2’ for 1T2R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the xTyR capability indicated by a LCID/eLCID codepoint can be one of {1T8R, 1T6R, 1T4R/2T8R, 2T6R, 1T2R/2T4R/4T8R, 1T=1R/2T=2R/4T=4R/8T8R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=1R, 2 ports for 2T8R, 2T6R, 2T4R and 2T=2R, 4 ports for 4T8R and 4T=4R and 8 ports for 8T8R. In one example, the number of ports is indicated in Msg3 or MsgA PUSCH.

In one example, N=14, and the xTyR capability indicated by a LCID/eLCID codepoint can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R}.

In one example, N=15, and the xTyR capability indicated by a LCID/eLCID codepoint can be one of {‘t1r1’ for 1T=1R, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘t8r8’ for 8T8R, or not supported}.

In one example, N=15, and the xTyR capability indicated by a LCID/eLCID codepoint can be one of {‘t1r1’ for 1T=IR, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R}.

In one example, N=16, and the xTyR capability indicated by a LCID/eLCID codepoint can be one of {‘t1r1’ for 1T=IR, ‘t2r2’ for 2T=2R, ‘t1r2’ for 1T2R, ‘t3r3’ for 3T=3R, ‘t3r6’ for 3T/6R, ‘t4r4’ for 4T=4R, ‘t2r4’ for 2T4R, ‘t1r4’ for 1T4R, ‘t2r6’ for 2T6R, ‘t1r6’ for 1T6R, ‘t4r8’ for 4T8R, ‘t2r8’ for 2T8R, ‘t1r8’ for 1T8R, ‘noTdm’ or ‘tdmAndNoTdm’ for 8T8R, or not supported}.

In one example, N=6, and the xTyR capability indicated by a LCID/eLCID codepoint can be one of {1T8R, 1T6R, 1T4R/2T8R, 2T6R, 1T2R/2T4R/3T6R/4T8R, 1T=1R/2T=2R/3T=3R/4T=4R/8T8R}. In one example, the number of SRS resources transmitted is one of {8, 6, 4, 3, 2, 1} respectively for each code point. In one example, the number of SRS ports per SRS resource is the number of Tx antennas, e.g., 1 port for 1T8R, 1T6R, 1T4R, 1T2R and 1T=IR, 2 ports for 2T8R, 2T6R, 2T4R and 2T=2R, 3 ports for 3T6R and 3T=3R, 4 ports for 4T8R and 4T=4R and 8 ports for 8T8R. In one example, the number of ports is indicated in Msg3 or MsgA PUSCH.

In one example, N=5, and the xTyR capability indicated by a LCID/eLCID codepoint can be one of {1T8R, 1T6R, 1T4R, 1T2R, or 1T=1R}.

In one example, N=6, and the xTyR capability indicated by a LCID/eLCID codepoint can be one of {1T8R, 1T6R, 1T4R, 1T2R, 1T=1R or not supported}.

In one example, N=4, and the xTyR capability indicated by a LCID/eLCID codepoint can be one of {1T8R, 1T4R, 1T2R, or 1T=1R}.

In one example, N=5, and the xTyR capability indicated by a LCID/eLCID codepoint can be one of {1T8R, 1T4R, 1T2R, 1T=1R or not supported}.

In a variant of the aforementioned examples, there are N codepoints indicated by the LCID/eLCID codepoint, wherein each code-point can be a subset of {1T=IR, 1T2R, 1T4R, 1T6R, 1T8R, 2T=2R, 2T/4R, 2T/6R, 2T/8R, 3T=3R, 3T/6R, 4T=4R, 4T8R, 8T8R}.

In a variant of the aforementioned examples the following examples are provided:
In one example, the early SRS capability and/or UE's SRS antenna switching xTyR capability can be indicated in Msg3 or MsgA PUSCH by including a MAC CE (e.g. SRS capability MAC CE) in Msg3 or MsgA MAC PDU wherein the MAC PDU include CCCH SDU and the MAC CE. One or more fields in the MAC CE indicate early SRS capability and/or UE's SRS antenna switching xTyR capability. In one example, UE can indicate that it supports early SRS through the PRACH preamble and in response network provides large enough grant in random access response to transmit Msg3 including UE's other SRS capabilities such as SRS antenna switching xTyR capability in MAC CE.
In one example, the one or more early SRS capability can be indicated by LCID/eLCID of CCCH SDU in Msg3 or MsgA PUSCH/MAC PDU and other SRS capability can be indicated by a MAC CE in Msg3 or MsgA PUSCH/MAC PDU.
In one example, the early SRS capability and/or UE's SRS antenna switching xTyR capability can be indicated in Msg3 or MsgA PUSCH/MAC PDU in LCID/eLCID of CCCH SDU.
In one example, the early SRS capability and/or UE's SRS antenna switching xTyR capability can be indicated in Msg3 or MsgA PUSCH/MAC PDU by a combination of LCID/eLCID of CCCH SDU and MAC CE (e.g., using one or more new fields). In one example, indication of xTyR, y/x can be indicated by LCID/eLCID, and x can be indicated by a new field in MAC CE. In one example, indication of xTyR, y/x can be indicated by LCID/eLCID, and y can be indicated by a new field in MAC CE. In one example, indication of xTyR, x can be indicated by LCID/eLCID, and y/x can be indicated by a new field in MAC CE. In one example, indication of xTyR, y can be indicated by LCID/eLCID, and y/x can be indicated by a new field in MAC CE. In one example, indication of xTyR, y can be indicated by LCID/eLCID, and x can be indicated by a new field in MAC CE. In one example, indication of xTyR, x can be indicated by LCID/eLCID, and y can be indicated by a new field in MAC CE.

In one example, an SRS transmission is triggered in the random access response (RAR) (e.g., Msg2) to a preamble transmission. In one example, an SRS transmission is triggered in the random access response (RAR) (e.g., Msg2) to a preamble transmission for a contention based random access procedure. In one example, an SRS transmission is triggered in the random access response (RAR) (e.g., Msg2) to a preamble transmission for a contention free random access procedure. In one example, the SRS is triggered in a RAR if the UE supports early SRS. In one example, the indication of the support of early SRS is indicated by the preamble and/or PRACH Occasion (RO) used for the random access procedure. For example, the preambles and/or ROs can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, a UE is configured e.g., by a field or flag in the system information to transmit SRS in response to receiving a RAR. The SRS transmission can be further conditioned on whether the UE transmits an associated PRACH preamble/RO from a first group of preambles/ROs or from a second group of preambles/ROs indicated in the system information. In one example, if a UE is configured by system information with a first set of preambles/ROs for “no early” SRS and a second of preambles/ROs for “early SRS”, the UE can:
If the UE transmits a preamble/RO associated with “no early SRS”, the UE doesn't expect to receive a trigger for early SRS in the RAR. In a variant example, if a UE receives a trigger for early SRS in the RAR, the UE ignores the trigger.
In one example, if the UE transmits a preamble/RO associated with “early SRS”, the RAR doesn't include a flag for early SRS trigger, the UE transmits the early SRS upon receiving the RAR.
In one example, if the UE transmits a preamble/RO associated with “early SRS”, the RAR includes a flag for early SRS trigger, based on the flag the UE transmits or doesn't transmit the early SRS upon receiving the RAR.

In one example, a UE is indicated in the RAR to transmit a SRS. In one example, a flag or a field in the RAR can indicate whether the UE transmits SRS in response to receiving the RAR. In one example, a field in the MAC sub-header for Random Access Response, e.g., a reserved field in the MAC sub-header for the Random Access Response can be used to trigger the SRS, for example, a value of “1” triggers the SRS, and a value of “0” doesn't trigger the SRS on vice versa. In one example, a field in the MAC RAR, e.g., a reserved field in the MAC RAR can be used to trigger the SRS, for example, a value of “1” triggers the SRS, and a value of “0” doesn't trigger the SRS or vice versa.

In one example, a UE is indicated by a flag (e.g., one-bit flag) or a special bit pattern in the RAR to transmit SRS. In one example, the UE transmits SRS instead of or in place of PUSCH Msg3. In one example, the UE transmits SRS in addition to PUSCH Msg3 (before or after PUSCH Msg3). In one example, the flag (e.g., one-bit flag) is included in the MAC sub-header for the Random Access Response, e.g., for Type-1 Random Access Procedure. In one example, the flag (e.g., one-bit flag) is included in the MAC RAR, e.g., for Type-1 Random Access Procedure. In one example, the flag (e.g., one-bit flag) is included in the UL Grant of the MAC RAR, e.g., for Type-1 Random Access Procedure. In one example, a special bit pattern of fields in the UL Grant of the MAC RAR, e.g., for Type-1 Random Access Procedure, indicates transmission of SRS. In one example, the flag (e.g., one-bit flag) is included in the DCI scheduling PDSCH of the MAC RAR. In one example, a special bit pattern of fields in the DCI scheduling the PDSCH of the MAC RAR indicates transmission of SRS.

In one example, a UE is indicated by a SRS resource filed in the RAR to use for SRS transmission. In one example, the UE transmits SRS instead of or in place of PUSCH Msg3. In one example, the UE transmits SRS in addition to PUSCH Msg3 (before or after PUSCH Msg3). In one example, the SRS resource is included in the MAC RAR, e.g., for Type-1 Random Access Procedure. In one example, the SRS resource is included in the UL Grant of the MAC RAR, e.g., for Type-1 Random Access Procedure. In one example, the SRS resource is included in the DCI scheduling the PDSCH of the MAC RAR. In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the preambles and/or ROs are portioned into N groups as aforementioned, the UE can determine the SRS resource based on the group of the preamble and/or RO, e.g., based on the antenna switching capability, in one example, one of the groups can be associated with no early SRS transmission. In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from the RAR, time offset from Msg3, or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the SRS resource.

In one example, a UE is indicated by a flag (e.g., one-bit flag) or a special bit pattern in the RAR to transmit SRS and is indicated an SRS resource in the RAR. In one example, the UE transmits SRS instead of or in place of PUSCH Msg3. In one example, the UE transmits SRS in addition to PUSCH Msg3 (before or after PUSCH Msg3). In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from the RAR, or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the MAC RAR includes parameters to schedule the SRS resource. The indication of the flag (e.g., one-bit flag) or special pattern and the SRS resource can follow one of the examples of Table 4.

In one example, the UE determines the early SRS resource or resources or SRS resource set to transmit based in the antenna switching capability if known. In one example, the antenna switching capability (e.g., xTyR or whether it is supported or not) is signaled based on a preamble and/or RO index or group as aforementioned. In one example, the antenna switching capability is signaled in Msg3, for an early SRS transmitted after Msg3, the network and UE can be aligned on the antenna switching capability and early SRS resource(s) used.

TABLE 4

| Example | flag (e.g., one-bit flag) | |
|---|---|---|
| number | or special pattern | SRS resource |
| Example 1 | MAC RAR | MAC RAR |
| Example 2 | MAC RAR | UL grant included in MAC RAR |
| Example 3 | MAC RAR | DCI Format scheduling PDSCH of |
| | | MAC RAR |
| Example 4 | UL grant included in MAC RAR | MAC RAR |
| Example 5 | UL grant included in MAC RAR | UL grant included in MAC RAR |
| Example 6 | UL grant included in MAC RAR | DCI Format scheduling PDSCH of |
| | | MAC RAR |
| Example 7 | DCI Format scheduling PDSCH of | MAC RAR |
| | MAC RAR | |
| Example 8 | DCI Format scheduling PDSCH of | UL grant included in MAC RAR |
| | MAC RAR | |
| Example 9 | DCI Format scheduling PDSCH of | DCI Format scheduling PDSCH of |
| | MAC RAR | MAC RAR |

In one example, M SRS resources or resource sets are configured by system information. In one example, the SRS resource set ID and/or the SRS resource ID transmitted by a UE is determined based on one or more of the following:
Based on a TC-RNTI conveyed by the RAR, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in or determined by a paging message that triggered the random access procedure associated with the RAR.
Based on the C-RNTI (or UE-ID), in Msg3, the UE and the gNB can identify a SRS resource (e.g., SRS resource in a stored context associated with the C-RNTI or the UE-ID).
Based on the preamble index associated with the RAR.
Based on the PRACH occasion (RO) associated with the RAR.
Based on the preamble index and PRACH occasion (RO) associated with the RAR.
Based on the group of the preamble and/or RO associated with the RAR as aforementioned.
Based on the antenna switching capability or a default antenna switching capability if antenna switching capability is unknown at the time of early SRS transmission or early SRS triggering.
The time and/or frequency resources of a PDCCH reception providing a DCI format scheduling a RAR or of the PDSCH reception providing the RAR.

In one example, in case of antenna switching, with multiple SRS resources or SRS resource sets, an SRS resource ID (and/or SRS resource set ID) can be determined by or be linked or mapped to multiple SRS resources or SRS resource sets based on the antenna switching capability, and the corresponding number of SRS resources.

In one example, the network configures SRS resource(s) or SRS resource set(s) for each preamble-ID. In one example, the network configures SRS resource(s) or SRS resource set(s) for each RO within a frame. In one example, the network configures SRS resource(s) or SRS resource set(s) for each RO within an association period. In one example, the network configures SRS resource(s) or SRS resource set(s) for each RO within an association pattern period. In one example, the network configures SRS resource(s) or SRS resource set(s) for each RO within N frames, wherein N is configured and/or updated RRC and/or MAC CE and L1 control (e.g., DCI format) signaling, or Nis specified in the system specifications, e.g., N=16, or N=8.

In one example, the network configures SRS resource(s) or SRS resource set(s) for each preamble-ID-RO pair. Wherein, RO can be:
Within a frame.
Within an association period.
Within an association pattern period.
Within N frames, wherein Nis configured and/or updated RRC and/or MAC CE and L1 control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the RAR and/or the RAR.
In a variant, the SRS configuration parameters (or a subset of them) for the SRS resource can be included in the DCI Format scheduling the RAR and/or the RAR instead of or in addition to the SRS ID. Wherein the configuration parameters for the SRS resource can be as aforementioned.

In one example, the SRS resource can be transmitted at or after a time T after the end (or start) of the PDSCH reception providing the RAR or of end (or start) of the PDCCH reception providing the DCI Format scheduling the RAR associated with the UE transmitting SRS. In one example, the slot or subframe or frame used to transmit SRS resource can be at or after a time T after the end (or start) or time unit (e.g., slot) of PDSCH reception providing the RAR or of end (or start) or time unit (e.g., slot) of the PDCCH reception providing the DCI Format scheduling the RAR associated with the UE transmitting SRS. In one example, the slot or subframe or frame used to transmit SRS resource is that first slot or subframe or frame that starts at or after a time T after the end (or start) or time unit (e.g., slot) of PDSCH reception providing the RAR or of end (or start) or time unit (e.g., slot) of PDCCH reception providing the DCI Format scheduling the RAR associated with the UE transmitting SRS and optionally based on an offset and a periodicity as illustrated in FIG. 15A (the SRS instances can be one-shot, N-shots or semi-persistent), where SRS trigger can be replaced by the PDSCH providing the RAR or the PDCCH providing the DCI Format scheduling the RAR associated with the UE transmitting SRS. Wherein, the time T can be defined in the system specifications and/or configured or updated by network (e.g., using SIB signaling and/or RRC signaling and/or MAC CE signaling and/or L1 control signaling).

In one example, the RAR and/or DCI scheduling the RAR includes a flag to trigger SRS. The SRS is transmitted after RACH Msg3. In one example, the UE has a stored context, and the stored context is associated with a C-RNTI (or a UE ID), for example the UE is in INACTIVE state. In one example, the UE transmits a C-RNTI MAC CE (or UE ID) in the Msg3, based on the C-RNTI (or UE-ID) the UE and the gNB can identify a SRS resource (e.g., SRS resource in a stored context associated with the C-RNTI or the UE-ID).

In one example, the RAR and/or DCI scheduling the RAR includes a flag to trigger SRS. The SRS is transmitted after RACH Msg3. In one example, Msg3 can convey antenna switching capability, and the SRS resource(s) is determined based on the antenna switching capability as aforementioned. In a variant example, the antenna switching capability is conveyed by a combination of signaling in the preamble/RO (e.g., based on preamble and/or RO group as aforementioned) and signaling in Msg3. In one example, early SRS capability in Msg3 is indicated by 1 bit in RRC message or using a specific LCID/eLCID in MAC PDU.

In one example, if the RAR includes a trigger for early SRS transmission, Msg3 can further include an indication whether or not the UE is transmitting the early SRS.

In one example, the SRS resource can be transmitted at or after a time T after the end (or start) of the PUSCH transmission containing Msg3 associated with the UE transmitting SRS. In one example, the slot or subframe or frame used to transmit SRS resource can be at or after a time T after the end (or start) or time unit (e.g., slot) of the PUSCH transmission containing Msg3 associated with the UE transmitting SRS. In one example, the slot or subframe or frame used to transmit SRS resource is that first slot or subframe or frame that starts at or after a time T after the end (or start) or time unit (e.g., slot) of the PUSCH transmission containing Msg3 associated with the UE transmitting SRS and optionally based on an offset and a periodicity as illustrated in FIG. 15A (the SRS instances can be one-shot, N-shots or semi-persistent), where SRS trigger can be replaced by the PUSCH transmission containing Msg3 associated with the UE transmitting SRS. Wherein, the time T can be defined in the system specifications and/or configured or updated by network (e.g., using SIB signaling and/or RRC signaling and/or MAC CE signaling and/or L1 control signaling).

In one example, an SRS transmission is triggered in contention resolution message providing a C-RNTI for the UE, or in Msg4, of a random access procedure. In one example, an SRS transmission is triggered in contention resolution message or Msg4 of a contention-based random access procedure. In one example, the SRS is triggered in a Msg4 if the UE supports early SRS. In one example, the indication of the support of early SRS is indicated by the preamble and/or PRACH Occasion (RO) used for the random access procedure. For example, the preambles and/or ROs can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, the indication of the support of early SRS is indicated by Msg3 (or MsgA) of the random access procedure. Support of early SRS can be indicated in MAC subheader (e.g. by using a pre-defined LCID or eLCID) or MAC CE or RRC message (e.g. RRC setup request or RRC resume request) included in Msg3/MsgA MAC PDU. In a variant example, Msg3 can indicate the UE's capability to support or not support early SRS, and/or the capability of the UE in regard to SRS antennas switching as aforementioned. In a variant example, the UE's capability to support or not support early SRS, and/or the antenna switching capability is conveyed by a combination of signaling in the preamble/RO (e.g., based on preamble and/or RO group as aforementioned) and signaling in Msg3.

In one example, a UE is configured e.g., by a field or flag in the system information to transmit SRS in response to receiving a contention resolution message, or in Msg4, or in a DCI Format scheduling Msg4 or MsgB. The SRS transmission can be further conditioned on whether the UE transmits an associated PRACH preamble from a first group of preambles or from a second group of preambles indicated in the system information. In one example, if a UE is configured by system information with a first set of preamble for “no early” SRS and a second of preambles for “early SRS”, the UE can:
If the UE transmits a preamble associated with “no early SRS”, the UE doesn't expect to receive a trigger for early SRS in a contention resolution message, or in Msg4, or in a DCI Format scheduling Msg4. In a variant example, if a UE receives a trigger for early SRS in a contention resolution message, or in Msg4, or in a DCI Format scheduling Msg4, the UE ignores the trigger.
In one example, if the UE transmits a preamble associated with “early SRS”, the contention resolution message, or Msg4, or DCI Format scheduling Msg4 doesn't include a flag for early SRS trigger, the UE transmits the early SRS upon receiving the contention resolution message, or Msg4, or DCI Format scheduling Msg4.
In one example, if the UE transmits a preamble associated with “early SRS”, the contention resolution message, or Msg4, or DCI Format scheduling Msg4 includes a flag for early SRS trigger, based on the flag the UE transmits or doesn't transmit the early SRS upon receiving the contention resolution message, or Msg4, or DCI Format scheduling Msg4.

In one example, a field in the DCI Format scheduling Msg4 can indicate whether or not the UE is triggered to transmit early SRS in response to Msg4. In one example, the field is 1-bit, “1” indicates that early SRS is triggered in response to Msg4, and “0” indicates that early SRS is not triggered in response to Msg4, or vice versa. In one example, the field is 2-bits (or in general n-bits), wherein a first value of the filed indicates that early SRS is not triggered in response to Msg4, and a second, third and fourth . . . values of the field indicate one of respective first, second and third, . . . configurations to use for early SRS. The first, second and third, . . . configurations can be configured in the SIB (e.g., SIB1), or provided by a configuration in Msg4.

In one example, when the field for indicating early SRS trigger is one-bit, the field for indicating early SRS trigger is provided by a bit (e.g., the MSB or LSB bit) of downlink assignment index field in the DCI Format scheduling Msg4. In one example, the second bit of the downlink assignment index field in the DCI Format scheduling Msg4 is reserved. In one example, the second bit of the downlink assignment index field in the DCI Format scheduling Msg4 is used to indicate a number of repetitions, if any, of PUCCH. In one example, whether the second bit of the downlink assignment index field in the DCI Format scheduling Msg4 is reserved or is used to indicate a number of repetitions, if any, of PUCCH Msg4 can be configured in the SIB.

In one example, when the field for indicating early SRS trigger is one-bit, the field for indicating early SRS trigger is provided by a bit (e.g., the MSB or LSB bit) of one of the following fields, the remaining bits can be used for the intended purpose:
Modulation and coding scheme (MCS) field, wherein the remaining bits (e.g., 4 bits) are used to indicate the MCS for Msg4.
Redundancy version (RV) field, wherein the remaining bits (e.g., 1 bit) is used to indicate the RV for Msg4 (e.g., RV can be 0 and 1, or 0 and 2, or 0 and 3).
HARQ process number (HPN) field, wherein the remaining bits (e.g., 3 bits) are used to indicate a HPN.
TPC command field, wherein the remaining bits (e.g., 1 bit) is used to indicate TPC value for PUCCH carrying Msg4 HARQ-ACK (e.g., a bit to indicate whether to increase or decrease power by a power step size in dB, or a bit to indicate whether to increase the power by a power step size in dB, or keep unchanged, or a bit to indicate whether to decrease the power by a power step size in dB, or keep unchanged)
PUCCH resource indicator (PRI) field, wherein the remaining bits (e.g., 2 bits) are used to indicate the PRI for Msg4 PUCCH.
PDSCH-to-HARQ feedback timing indicator (PHFTI) field, wherein the remaining bits (e.g., 2 bits) are used to indicate the PHFTI for Msg4 PUCCH.

In one example, when the field for indicating early SRS trigger is two-bits, the field for indicating early SRS trigger is provided by the downlink assignment index field in the DCI Format scheduling Msg4. In one example, whether the downlink assignment index field in the DCI Format scheduling Msg4 is reserved or is used for early SRS triggering and/or is used to indicate a number of repetitions, if any, of PUCCH Msg4 can be configured by the SIB (e.g., SIB1) or dynamically indicated by another field in the DCI Format scheduling Msg4.

In one example, when the field for indicating early SRS trigger is two-bits, the field is provided by two bits (e.g., the two MSB or two LSB bits of a field-when the field has more than 2 bits) of one of the following fields, the remaining bits can be used for the intended purpose:
Modulation and coding scheme (MCS) field, wherein the remaining bits (e.g., 3 bits) are used to indicate the MCS for Msg4.
Redundancy version (RV) field, wherein the RV of Msg4 is 0, e.g., RV field has 2 bits.
HARQ process number (HPN) field, wherein the remaining bits (e.g., 2 bits) are used to indicate a HPN.
TPC command field, wherein the power of the Msg4 PUCCH remains unchanged, e.g., TPC field has 2 bits.
PUCCH resource indicator (PRI) field, wherein the remaining bits (e.g., 1 bit) is used to indicate the PRI for Msg4 PUCCH.
PDSCH-to-HARQ feedback timing indicator (PHFTI) field, wherein the remaining bit (e.g., 1 bit) is used to indicate the PHFTI for Msg4 PUCCH.

In one example, when the field for indicating early SRS trigger is two-bits, the field is provided by a first bit (e.g., the MSB or LSB bit of first field) of one of the following fields, and second bit (e.g., the MSB or LSB bit of a second field) of one of the following fields, the remaining bits can be used for the intended purpose:
Modulation and coding scheme (MCS) field, wherein the remaining bits (e.g., 4 bits) are used to indicate the MCS for Msg4.
Redundancy version (RV) field, wherein the remaining bits (e.g., 1 bit) is used to indicate the RV for Msg4 (e.g., RV can be 0 and 1, or 0 and 2, or 0 and 3).
HARQ process number (HPN) field, wherein the remaining bits (e.g., 3 bits) are used to indicate a HPN.
TPC command field, wherein the remaining bit (e.g., 1 bit) is used to indicate TPC value for PUCCH carrying Msg4 HARQ-ACK (e.g., a bit to indicated whether to increase or decrease power by a power step size in dB, or a bit to indicate whether to increase the power by a power step size in dB, or keep unchanged, or a bit to indicate whether to decrease the power by a power step size in dB, or keep unchanged)
PUCCH resource indicator (PRI) field, wherein the remaining bits (e.g., 2 bits) are used to indicate the PRI for Msg4 PUCCH.
PDSCH-to-HARQ feedback timing indicator (PHFTI) field, wherein the remaining bits (e.g., 2 bits) are used to indicate the PHFTI for Msg4 PUCCH.

In a variant example, a field is added to the DCI Format scheduling Msg4 for early SRS triggering. In one example, the field for early SRS triggering is 1-bit. In one example, the field for early SRS triggering is 2-bits. In one example, the field for early SRS triggering is n-bits. In one example, whether the field for early SRS triggering is added to the DCI Format scheduling Msg4, can be based on indication in Msg1 (PRACH preamble), or Msg3, e.g., based on whether or not the UE supports early SRS triggering. In one example, the size of the field added (e.g., n) can be based on configuration in SIB (e.g., SIB1 or SIB2), e.g., SIB can configure n, or SIB can configure a number of early SRS configurations, N, for early SRS transmission, and n=┌log₂(N+1)┐, or =┌log₂ N┐.

In the aforementioned examples, Msg4 can be replaced by MsgB, and DCI Format scheduling Msg4 can be replaced by DCI Format scheduling MsgB, and Msg4 PUCCH can be replaced by MsgB PUCCH, and Msg1 (PRACH preamble) can be replaced MsgA PRACH, and Msg3 can be replaced MsgA PUSCH.

In the aforementioned examples, early SRS triggering, can be replaced by early CSI-RS measurement and/or early CSI reporting, wherein the trigger can be for early measuring of CSI-RS (or SSB) using configured resources (e.g., in SIB1 or in Msg4) and/or early reporting of CSI on uplink resources (e.g., PUCCH or PUSCH) wherein the UL resources and report configuration are configured by SIB1 or in Msg4.

For brevity, only the contention resolution message is referred to in the following.

In one example, a UE is indicated in the contention resolution message or Msg4 to transmit a SRS. In one example, a flag or a field in the contention resolution message can indicate whether the UE transmits SRS in response to receiving the contention resolution message or Msg4.

In one example, a MAC CE in the contention resolution message or Msg4 can provide a configuration for SRS transmission by the UE.

In one example, the UE determines the early SRS resource or resources to transmit based in the antenna switching capability if known. In one example, the antenna switching capability (e.g., xTyR or whether it is supported or not) is signaled based on a preamble and/or RO index or group and/or signaling in Msg3 as aforementioned.

In one example, M SRS resources or SRS resource sets are configured by system information. In one example, the SRS resource ID (and/or SRS resource set ID) transmitted by a UE is determined based on one or more of the following:
Based on a C-RNTI conveyed by the contention resolution, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a SRS resource (e.g., SRS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the contention resolution.
Based on the preamble index associated with the random access procedure.
Based on the PRACH occasion (RO) associated with the RAR.
Based on the preamble index and PRACH occasion (RO) associated with the RAR.
Based on the group of the preamble and/or RO associated with the RAR as aforementioned.
Based on signaling in Msg3.
Based on the antenna switching capability or a default antenna switching capability if antenna switching capability is unknown at the time of early SRS transmission or early SRS triggering.
The time and/or frequency resources of a DCI format scheduling a contention resolution/Msg4 or of the contention resolution/Msg4.
Based on the resource used for HARQ-ACK acknowledgment of contention resolution/Msg4.
Based on an information provided by a MAC CE in the contention resolution message/Msg4.

In one example, in case of antenna switching, with multiple SRS resources or SRS resource sets, an SRS resource ID (and/or SRS resource set ID) can be determined by or be linked or mapped to multiple SRS resources or SRS resource sets based on the antenna switching capability, and the corresponding number of SRS resources.

In one example, the network configures SRS resource(s) or SRS resource set(s) for each preamble-ID. In one example, the network configures SRS resource(s) or SRS resource set(s) for each RO within a frame. In one example, the network configures SRS resource(s) or SRS resource set(s) for each RO within an association period. In one example, the network configures SRS resource(s) or SRS resource set(s) for each RO within an association pattern period. In one example, the network configures SRS resource(s) or SRS resource set(s) for each RO within N frames, wherein N is configured and/or updated RRC and/or MAC CE and L1 control (e.g., DCI format) signaling, or Nis specified in the system specifications, e.g., N=16, or N=8.

In one example, the network configures SRS resource(s) or SRS resource set(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration. In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the contention resolution or Msg4 and/or in the contention resolution message or Msg4.
In a variant, the SRS configuration parameters (or a subset of them) for the SRS resource can be included in the DCI Format scheduling the contention resolution message or Msg4 and/or in the contention resolution message or Msg4 instead of or in addition to the SRS ID. Wherein the configuration parameters for the SRS resource can be as aforementioned.

In one example, the SRS resource can be transmitted at or after a time T after the end (or start) of the PDSCH reception providing the contention resolution message or Msg4 or of the PDCCH reception providing the DCI Format scheduling the contention resolution message or Msg4 associated with the UE transmitting SRS. In one example, the slot or subframe or frame used to transmit SRS resource can be at or after a time T after the end (or start) or time unit (e.g., slot) of the PDSCH reception providing the contention resolution message or Msg4 or of the PDCCH reception providing the DCI Format scheduling the contention resolution message or Mgs4 associated with the UE transmitting SRS. In one example, the slot or subframe or frame used to transmit SRS resource is that first slot or subframe or frame that starts at or after a time T after the end (or start) or time unit (e.g., slot) of the PDSCH reception providing the contention resolution message or Msg4 or of the PDCCH reception providing the DCI Format scheduling the contention resolution message or Msg4 associated with the UE transmitting SRS and optionally based on an offset and a periodicity as illustrated in FIG. 15A (the SRS instances can be one-shot, N-shots or semi-persistent), where SRS trigger can be replaced by the PDSCH providing the contention resolution message/Msg4 or the PDCCH providing the DCI Format scheduling the contention resolution message/Msg4 associated with the UE transmitting SRS transmission. Wherein, the time T can be defined in the system specifications and/or configured or updated by network (e.g., using SIB signaling and/or RRC signaling and/or MAC CE signaling and/or L1 control signaling).

In one example, an SRS transmission is triggered in MsgB of a Type-2 random access procedure. In one example, MsgB is for successRAR. In one example, MsgB is for a fallback RAR. In one example, an SRS transmission is triggered in MsgB successRAR of a contention-based random access procedure. In one example, an SRS transmission is triggered in MsgB fallbackRAR of a contention-free random access procedure. In one example, the SRS is triggered in a successRAR or fallbackRAR if the UE supports early SRS. In one example, the indication of the support of early SRS is indicated by the preamble and/or PRACH Occasion (RO) used for the Type-2 random access procedure. For example, the preambles and/or ROs of the MsgA PRACH can be partitioned into 2 groups g₀, g₁, if a UE doesn't support early SRS or doesn't request early SRS a preamble and/or RO in the first group is used (e.g. g₀), if a UE supports early SRS or supports and requests early SRS, a preamble and/or RO in the second group is used (e.g. g₁). In a variant example, there are N groups of preambles and/or ROs, as aforementioned, wherein the N groups can indicate the UE's capability to support or not support early SRS, and/or the capability of the UE in regard to SRS antennas switching as aforementioned.

In one example, the indication of the support of early SRS is indicated by MsgA PUSCH of the random access procedure. In a variant example, MsgA PUSCH can indicate the UE's capability to support or not support early SRS, and/or the capability of the UE in regard to SRS antennas switching as aforementioned. In a variant example, the UE's capability to support or not support early SRS, and/or the antenna switching capability is conveyed by a combination of signaling in the preamble/RO of MsgA PRACH (e.g., based on preamble and/or RO group as aforementioned) and signaling in MsgA PUSCH. In one example, early SRS capability in MsgA is indicated by 1 bit in RRC message or using a specific LCID/eLCID in MAC PDU.

In one example, a UE is configured e.g., by a field or flag in the system information to transmit SRS in response to receiving a MsgB. The SRS transmission can be further conditioned on whether the UE transmits an associated MsgA PRACH preamble/RO from a first group of preambles/ROs or from a second group of preambles/ROs indicated in the system information. In one example, if a UE is configured by system information with a first set of preamble for “no early” SRS and a second of preambles for “early SRS”, the UE can:
If the UE transmits a preamble/RO associated with “no early SRS”, the UE doesn't expect to receive a trigger for early SRS in the successRAR or fallbackRAR or MsgB. In a variant example, if a UE receives a trigger for early SRS in the successRAR or fallbackRAR, the UE ignores the trigger.
In one example, if the UE transmits a preamble/RO associated with “early SRS”, the successRAR or fallbackRAR or MsgB or DCI scheduling MsgB doesn't include a flag for early SRS trigger, the UE transmits the early SRS upon receiving the successRAR or fallbackRAR.
In one example, if the UE transmits a preamble/RO associated with “early SRS”, the successRAR or fallbackRAR or MsgB or DCI scheduling MsgB includes a flag for early SRS trigger, based on the flag in the UE transmits or doesn't transmit the early SRS upon receiving the successRAR or fallbackRAR or MsgB or DCI scheduling MsgB.

In one example, a UE is indicated in the MsgB or DCI scheduling MsgB to transmit a SRS. In one example, a flag or a field in the MsgB can indicate whether the UE transmits SRS in response to receiving the MsgB. In one example, MsgB can include a fallback RAR. In one example, MsgB can include a success RAR. In one example, a field in the MAC sub-header for success RAR or the fallback RAR, e.g., a reserved field in the MAC sub-header for the success RAR or fallback RAR can be used to trigger the SRS, for example, a value of “1” triggers the SRS, and a value of “0” doesn't trigger the SRS or vice versa. In one example, a field in the success RAR or fallback RAR, e.g., a reserved field in the success RAR or fallback RAR can be used to trigger the SRS, for example, a value of “1” triggers the SRS, and a value of “0” doesn't trigger the SRS or vice versa.

In one example, a UE is indicated by a flag (e.g., one-bit flag) or a special bit pattern in the MsgB (e.g., fallbackRAR or successRAR) or DCI scheduling Msg4 to transmit SRS. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the flag (e.g., one-bit flag) is included in the MAC sub-header for the success RAR or fallback RAR, e.g., for Type-2 Random Access Procedure. In one example, the flag (e.g., one-bit flag) is included in MsgB (e.g., fallbackRAR or successRAR), e.g., for Type-2 Random Access Procedure. In one example, the flag (e.g., one-bit flag) is included in the UL Grant of MsgB (e.g., fallbackRAR), e.g., for Type-2 Random Access Procedure. In one example, a special bit pattern of fields in the UL Grant of MsgB (e.g., fallbackRAR), e.g., for Type-2 Random Access Procedure, indicates transmission of SRS. In one example, the flag (e.g., one-bit flag) is included in the DCI scheduling PDSCH of MsgB (e.g., fallbackRAR or successRAR). In one example, a special bit pattern of fields in the DCI scheduling the PDSCH of MsgB (e.g., fallbackRAR or successRAR) indicates transmission of SRS.

In one example, a UE is indicated by a SRS resource in MsgB (e.g., fallbackRAR or successRAR) to use for SRS transmission. In one example, the UE transmits SRS instead of or in place of PUSCH Msg3. In one example, the UE transmits SRS in addition to PUSCH Msg3, e.g., scheduled by fallbackRAR, (before or after PUSCH Msg3). In one example, the SRS resource is included in MsgB (e.g., fallbackRAR or successRAR), e.g., for Type-2 Random Access Procedure. In one example, the SRS resource is included in the UL Grant of MsgB (e.g., fallbackRAR), e.g., for Type-2 Random Access Procedure. In one example, the SRS resource is included in the DCI scheduling the PDSCH of MsgB (e.g., fallbackRAR or successRAR). In one example, the SRS resource is linked to (associated with) the preamble index. In one example, the SRS resource is linked to (associated with) the PRACH occasion. In one example, the SRS resource is linked to (associated with) the preamble index and the PRACH occasion. In one example, the preambles and/or ROs of MsgA PRACH are portioned into N groups as aforementioned, the UE can determine the SRS resource based on the group of the preamble and/or RO, e.g., based on the antenna switching capability, in one example, one of the groups can be associated with no early SRS transmission. In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR), or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource.

In one example, a UE is indicated by a flag (e.g., one-bit flag) or a special bit pattern in MsgB (e.g., fallbackRAR or successRAR) to transmit SRS and is indicated an SRS resource in MsgB (e.g., fallbackRAR or successRAR). In one example, the UE transmits SRS instead of or in place of PUSCH Msg3, e.g., scheduled by fallbackRAR. In one example, the UE transmits SRS in addition to PUSCH Msg3 (before or after PUSCH Msg3). In one example, the SRS resource includes a SRS resource ID and/or SRS resource set ID configured to the UE from a list of SRS resources and/or a list of SRS resource sets configured to the UE, wherein the configuration can be by SIB signaling or by RRC signaling. In one example, the SRS resource includes configuration/scheduling parameters for the SRS, such as time domain resources (e.g., symbol(s) in a slot to use for SRS, time offset from MsgB (e.g., fallbackRAR or successRAR), or time offset within a period, SRS period, etc.), frequency domain resources (e.g., starting RB, number of RBs, frequency hopping pattern, etc.), comb parameters (e.g., comb size, comb offset, cyclic shift, etc.), sequence, sequence hopping (e.g., group hopping, sequence hopping or neither, etc.). In one example, the UL grant of the fallbackRAR includes parameters to schedule the SRS resource. In one example, the successRAR includes an UL grant with parameters to schedule the SRS resource. The indication of the flag (e.g., one-bit flag) or special pattern and the SRS resource can follow one of the examples of Table 5.

In one example, the UE determines the early SRS resource or resources to transmit based in the antenna switching capability if known. In one example, the antenna switching capability (e.g., xTyR or whether it is supported or not) is signaled based on a preamble and/or RO index or group of MsgA PRACH and/or signaling in MsgA PUSCH as aforementioned. Examples 1, 3, 7 and 9 of Table 5, can also apply to Msg4, as described herein.

TABLE 5

| Example | flag (e.g., one-bit flag) | |
|---|---|---|
| number | or special pattern | SRS resource |
| Example 1 | MsgB (e.g., fallbackRAR or | MsgB (e.g., fallbackRAR or |
| | successRAR), or | successRAR), or |
| | Msg4 | Msg4 |
| Example 2 | MsgB (e.g., fallbackRAR or | UL grant included in MsgB (e.g., |
| | successRAR) | fallbackRAR) |
| Example 3 | MsgB (e.g., fallbackRAR or | DCI Format scheduling PDSCH of MsgB |
| | successRAR), or | (e.g., fallbackRAR or successRAR), or |
| | Msg4 | DCI Format scheduling PDSCH of Msg4 |
| Example 4 | UL grant included in MsgB (e.g., | MsgB (e.g., fallbackRAR or successRAR) |
| | fallbackRAR) | |
| Example 5 | UL grant included in MsgB (e.g., | UL grant included in MsgB (e.g., |
| | fallbackRAR) | fallbackRAR) |
| Example 6 | UL grant included in MsgB (e.g., | DCI Format scheduling PDSCH of MsgB |
| | fallbackRAR) | (e.g., fallbackRAR or successRAR) |
| Example 7 | DCI Format scheduling PDSCH of | MsgB (e.g., fallbackRAR or |
| | MsgB (e.g., fallbackRAR or | successRAR), or |
| | successRAR), or | Msg4 |
| | DCI Format scheduling PDSCH of | |
| | Msg4 | |
| Example 8 | DCI Format scheduling PDSCH of | UL grant included in MsgB (e.g., |
| | MsgB (e.g., fallbackRAR or | fallbackRAR) |
| | successRAR) | |
| Example 9 | DCI Format scheduling PDSCH of | DCI Format scheduling PDSCH of MsgB |
| | MsgB (e.g., fallbackRAR or | (e.g., fallbackRAR or successRAR), or |
| | successRAR), or | DCI Format scheduling PDSCH of Msg4 |
| | DCI Format scheduling PDSCH of | |
| | Msg4 | |

In one example, M SRS resources are configured by system information. In one example, the SRS resource ID (and/or SRS resource set ID) transmitted by a UE is determined based on one or more of the following:
Based on a C-RNTI conveyed by the MsgB, e.g. the n least significant bits of the C-RNTI, or the n most significant bits of the C-RNTI, or indicated ID is C-RNTI % N, or indicated ID is ceiling (C-RNTI/N).
Based on the C-RNTI (or UE-ID) the UE and the gNB can identify a SRS resource (e.g., SRS resource in a stored context associated with the C-RNTI or the UE-ID).
Based on a TC-RNTI used by the random access procedure, e.g. the n least significant bits of the TC-RNTI, or the n most significant bits of the TC-RNTI, or indicated ID is TC-RNTI % N, or indicated ID is ceiling (TC-RNTI/N).
Based on a UE-ID indicated in a paging message that triggered the random access procedure associated with the MsgB.
Based on the preamble index associated with the random access procedure.
Based on the PRACH occasion (RO) associated with the RAR.
Based on the preamble index and PRACH occasion (RO) associated with the RAR.
Based on the group of the preamble and/or RO of MsgA PRACH associated with the successRAR or fallbackRAR as aforementioned.
Based on signaling in MsgB.
Based on the antenna switching capability or a default antenna switching capability if antenna switching capability is unknown at the time of early SRS transmission or early SRS triggering.
The time and/or frequency resources of a DCI format scheduling a MsgB or of the MsgB.
Based on the resource used for HARQ-ACK acknowledgment of MsgB.
Based on an information provided by a MAC CE of MsgB (e.g., success RAR or fallback RAR).

In one example, in case of antenna switching, with multiple SRS resources or SRS resource sets, an SRS resource ID (and/or SRS resource set ID) can be determined by or be linked or mapped to multiple SRS resources or SRS resource sets based on the antenna switching capability, and the corresponding number of SRS resources.

In one example, the network configures SRS resource(s) or SRS resource set(s) for each preamble-ID. In one example, the network configures SRS resource(s) or SRS resource set(s) for each RO within a frame. In one example, the network configures SRS resource(s) or SRS resource set(s) for each RO within an association period. In one example, the network configures SRS resource(s) or SRS resource set(s) for each RO within an association pattern period. In one example, the network configures SRS resource(s) or SRS resource set(s) for each RO within N frames, wherein N is configured and/or updated RRC and/or MAC CE and L1 control (e.g., DCI format) signaling, or Nis specified in the system specifications, e.g., N=16, or N=8.

In one example, the network configures SRS resource(s) or SRS resource set(s) for each preamble-ID-RO pair. Wherein, RO can be:
Within a frame.
Within an association period.
Within an association pattern period.
Within N frames, wherein N is configured and/or updated RRC and/or MAC CE and L1 control (e.g., DCI format) signaling, or N is specified in the system specifications, e.g., N=16, or N=8.

In one example, this mapping between the SRS resource ID (and/or SRS resource set ID) and the aforementioned parameters is based on a rule. In one example, this mapping between the SRS resource ID (and/or SRS resource set ID) and the aforementioned parameters is based on a network configuration. In one example, this mapping between the SRS resource ID (and/or SRS resource set ID) and the aforementioned parameters is based on a combination of a rule and network configuration.

In one example, the SRS resource ID (and/or SRS resource set ID) transmitted by a UE is determined based on one or more of the following:
A SRS ID of the M SRS resource IDs (and/or SRS resource set IDs) configured by system information, wherein the SRS resource ID (and/or SRS resource set ID) is included in the DCI Format scheduling the MsgB and/or the MsgB.
In a variant, the SRS configuration parameters (or a subset of them) for the SRS resource can be included in the DCI Format scheduling the MsgB and/or the MsgB instead of or in addition to the SRS ID. Wherein the configuration parameters for the SRS resource can be as aforementioned.

In one example, the SRS resource can be transmitted at or after a time T after the end (or start) of the PDSCH reception providing MsgB or of the PDCCH reception providing the DCI Format scheduling the MsgB associated with the UE transmitting SRS. In one example, the slot or subframe or frame used to transmit SRS resource can be at or after a time T after the end (or start) or time unit (e.g., slot) of the PDSCH reception providing MsgB or of the PDCCH reception providing the DCI Format scheduling the MsgB associated with the UE transmitting SRS. In one example, the slot or subframe or frame used to transmit SRS resource is that first slot or subframe or frame that starts at or after a time T after the end (or start) or time unit (e.g., slot) of the PDSCH reception providing MsgB or of the PDCCH reception providing the DCI Format scheduling the MsgB associated with the UE transmitting SRS and optionally based on an offset and a periodicity as illustrated in FIG. 15A (the SRS instances can be one-shot, N-shots or semi-persistent), where SRS trigger can be replaced by the MsgB or the PDCCH reception providing the DCI Format scheduling the MsgB associated with the UE transmitting SRS. Wherein, the time T can be defined in the system specifications and/or configured or updated by network (e.g., using SIB signaling and/or RRC signaling and/or MAC CE signaling and/or L1 control signaling).

In the aforementioned examples,
UE transmits a preamble for a Type-1 random access procedure or a Type-2 random access procedure. In one example, a Type-2 random access procedure includes a PRACH and a PUSCH.
In one example, the preambles and/or ROs are partitioned into 2 groups or into groups, wherein the preamble and/or RO group used for the random access procedure can indicate whether or not the UE supports early SRS. In other examples, the preamble and/or RO group used for the random access procedure can indicate an SRS antenna switching capability (xTyR) or the UE doesn't support SRS antenna switching. In other examples, the preamble and/or RO group used for the random access procedure can indicate an SRS antenna switching capability (xTyR).
In one example, for Type-2 random access procedure, MsgA PRACH (based on preamble and/or RO group) and/or MsgA PUSCH (based on signaling in MsgA PUSCH) can indicate capability of UE to support early SRS and/or SRS antenna switching capability (xTyR) and/or the UE doesn't support SRS antenna switching.
The network responds to the preamble of the Type-1 random access procedure or the Type-2 random access procedure, with a RAR or a success RAR or a fallback RAR.
   In one example, the RAR or a success RAR or a fallback RAR includes a trigger for SRS,
   In one example, the RAR or a success RAR or a fallback RAR indicates a resource(s) for SRS, e.g., explicitly or based on preamble ID or RO or TC-RNTI or C-RNTI or antenna switching capability if known, or default antenna switching capability as aforementioned.
   In one example, the SRS resource(s) is transmitted before Msg3.
   In one example, the SRS resource(s) is transmitted after Msg3. In a further example, Msg3 can indicate capability of UE to support early SRS and/or SRS antenna switching capability (xTyR) or the UE doesn't support SRS antenna switching, transmission of early SRS and/or early SRS resource(s) can be based on signaling in Msg3,
   In one example, the SRS resource is transmitted with (or as part of) Msg3.
   In one example, the SRS resource is transmitted after Msg4.
   In one example, the SRS resource is transmitted after UE is in connected state.
For type 1 random access procedure, the UE transmits Msg3. In one example, Msg3 includes C-RNTI MAC CE or CCCH SDU.
In one example, for Type-1 random access procedure, Msg3 (based on preamble and/or RO group) and/or MsgA PUSCH (based on signaling in MsgA PUSCH) can indicate capability of UE to support early SRS and/or SRS antenna switching capability (xTyR) or the UE doesn't support SRS antenna switching.
The network responds to the Msg3 of the Type-1 random access procedure with a Msg4
   In one example, the Msg4 or DCI scheduling Msg4 includes a trigger for SRS,
   In one example, the Msg4 indicates a resource for SRS, e.g., explicitly or based on preamble ID or RO or TC-RNTI or C-RNTI or antenna switching capability if known, or default antenna switching capability as aforementioned.
   In one example, the SRS resource is transmitted after UE is in connected state.

In the aforementioned examples, the early SRS is triggered in Msg2 or Msg4 or MsgB or DCI scheduling Msg2 or Msg4 or MsgB and the transmission of early SRS occurs after Msg5 (e.g., connection setup complete or resume setup complete).

In one example, the early SRS capability and/or SRS antenna switching capability is indicated in Msg5 (e.g., connection setup complete or resume setup complete). The examples in this disclosure for signaling the early SRS capability and/or SRS antenna switching capability in Msg3 can be extended to Msg5.

In one example, the early SRS capability and/or SRS antenna switching capability is indicated in a PUCCH and/or PUSCH message the UE transmits after Msg5 (e.g., connection setup complete or resume setup complete).

In one example, the early SRS capability and/or SRS antenna switching capability is indicated in a PUCCH and/or PUSCH message the UE transmits after UE capability exchange between UE and gNB.

In one example, the early SRS capability and/or SRS antenna switching capability is determined after network determines UE context associated with the UE triggering the random access procedure for a UE in the INACTIVE state. In one example, the early SRS capability and/or SRS antenna switching capability is determined after Resume Request message (e.g., Msg3) for a UE in the INACTIVE state.

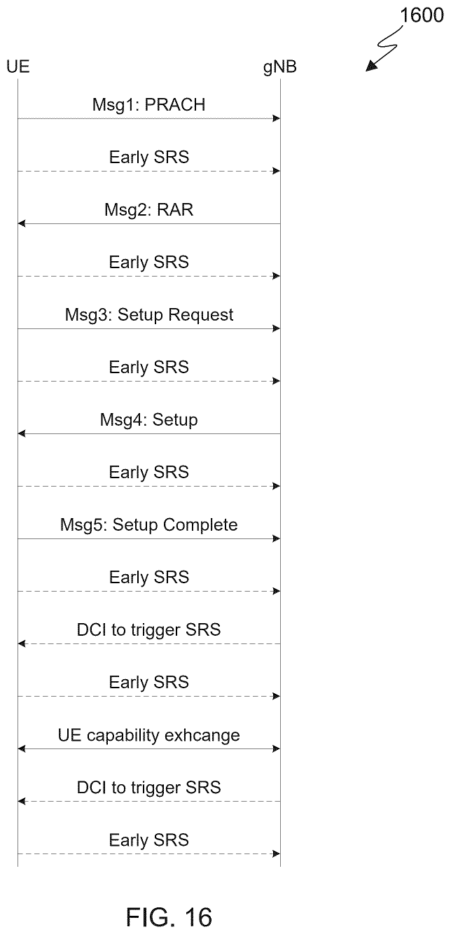

FIG. 16 illustrates an example procedure 1600 for early SRS triggering for idle mode according to embodiments of the present disclosure. The procedure 1600 of FIG. 16 can be performed by any of the UEs 111-116 of FIG. 1, such as the UE 116 of FIG. 3, and any of the BSs 101-103 of FIG. 1, such as BS 102 of FIG. 2. The procedure 16 is for illustration only and other embodiments can be used without departing from the scope of the present disclosure.

For idle mode UEs, as illustrated in FIG. 16, the following is a summary of the aforementioned options. The dotted lines in FIG. 16 illustrated possible options for transmitting SRS or for triggering SRS by DCI.

| | |
|---|---|
| Early SRS capability | Provided by: |
| | Msg1 (PRACH): Alt1 |
| | Msg3 (e.g., Connection Setup Request): Alt2 |
| | Msg5 (e.g., Connection Setup Complete): Alt3 |
| | Determined implicitly by network based on DTX detection of SRS: |
| | Alt4 |
| SRS Antenna | Provided by: |
| switching capability | Msg1 (PRACH) |
| or configuration | Msg3 (e.g., Connection Setup Request) |
| | Msg5 (e.g., Connection Setup Complete) |
| Early SRS resource | Provided by: |
| and/or resources set | SIBx configuration (e.g., SIB1). e.g., based on configuration of SRS |
| configuration | resources and/or SRS resource sets, or based on association between |
| | preamble and/or RO and SRS resources and/or SRS resource sets. |
| | Msg4 (Connection setup) |
| Trigger for SRS | Provided by: |
| | Msg2 (RAR): Alt1a (implicit . . . no flag), Alt1b (explicit . . . flag) |
| | Msg4 (e.g., Connection setup): Alt1c/Alt2a (implicit . . . no flag), |
| | Alt1d/Alt2b (explicit . . . flag) |
| | PDCCH trigger after Msg5 (e.g., Connection setup complete): |
| | Alt1e/Alt2c/Alt3c |
| Resource used for | Determined based on: |
| early SRS | Default antenna switching capability if SRS antenna switching |
| | capability is unknown. |
| | SRS antenna switching capability. |

| | Alt1 | Alt2 | Alt3 | Alt4 |
|---|---|---|---|---|
| SIBx | Preamble/RO | Opt1: Configure | Opt1: Configure | Opt1: Configure |
| | config: 2 groups | early SRS | early SRS | early SRS |
| | early SRS support | resources | resources | resources |
| | Optional N | | | |
| | groups for SRS | | | |
| | antenna switching | | | |
| | capability | | | |
| | indication. | | | |
| | Configure early | | | |
| | SRS resources | | | |
| Msg1 (Preamble) | Group 0: No early | | | |
| | SRS | | | |
| | Group 1: Early | | | |
| | SRS | | | |
| | Other groups to | | | |
| | optionally | | | |
| | indicate SRS | | | |
| | antenna switching | | | |
| | capability | | | |
| Msg2 (RAR) | Alt1a: Implicit | | Alt3a: Trigger for | Alt4a: Flag to |
| | trigger of early | | early SRS. | trigger early SRS |
| | SRS based on | | Early SRS sent | If UE doesn't |
| | preamble/RO | | after Msg5 | support early |
| | group | | | SRS, flag is |
| | Alt1b: Flag to | | | ignored and there |
| | trigger early SRS | | | is no early SRS is |
| | If SRS antenna | | | transmitted. |
| | switching | | | |
| | capability is | | | |
| | unknown use | | | |
| | default resources. | | | |
| Msg3 | Can optionally | Msg3 can indicate | | |
| (Connection | indicate SRS | support for early | | |
| Setup request) | antenna switching | SRS and | | |
| | capability. SRS | optionality SRS | | |
| | resource(s) | antenna switching | | |
| | determined based | capability. | | |
| | on indicated | | | |
| | capability if SRS | | | |
| | transmitted after | | | |
| | Msg3 | | | |
| Msg4 | Alt1c: Implicit | Opt2: Msg4 can | Opt2: Msg4 can | Opt2: Msg4 can |
| (Connection | trigger of early | provide SRS | provide SRS | provide SRS |
| setup) | SRS based on | resources | resources | resources |
| | preamble/RO | Alt2a: Implicit | Alt3b: Trigger for | Alt4b: Flag to |
| | group. | trigger of early | early SRS. | trigger early SRS |
| | Alt1d: Flag to | SRS based on | Early SRS sent | |
| | trigger early SRS | Msg3 indication. | after Msg5 | |
| | Default SRS | Alt2b: Flag to | | |
| | antenna switching | trigger early SRS | | |
| | capability is used. | Default SRS | | |
| | Alternatively, | antenna switching | | |
| | SRS antenna | capability is used. | | |
| | switch capability | Alternatively, | | |
| | is used if signaled | SRS antenna | | |
| | in Msg3 | switch capability | | |
| | | is used if signaled | | |
| | | in Msg3 | | |
| Msg5 | Alt1e: PDDCH | Alt2c: PDDCH | Msg5 can indicate | |
| (Connection | after Msg5 can | after Msg5 can | support for early | |
| setup | trigger early SRS | trigger early SRS | SRS and | |
| complete | transmission | transmission | optionally SRS | |
| | based on early | based on early | antenna switching | |
| | SRS capability | SRS capability | capability. | |
| | and optionally | and optionally | Alt3c: PDDCH | |
| | based on SRS | based on SRS | after Msg5 can | |
| | antenna switching | antenna switching | trigger early SRS | |
| | capability | capability | transmission | |
| | | | based on early | |
| | | | SRS capability | |
| | | | and optionally | |
| | | | based on SRS | |
| | | | antenna switching | |
| | | | capability | |
| After UE | | | | |
| capability is | | | | |
| known | | | | |

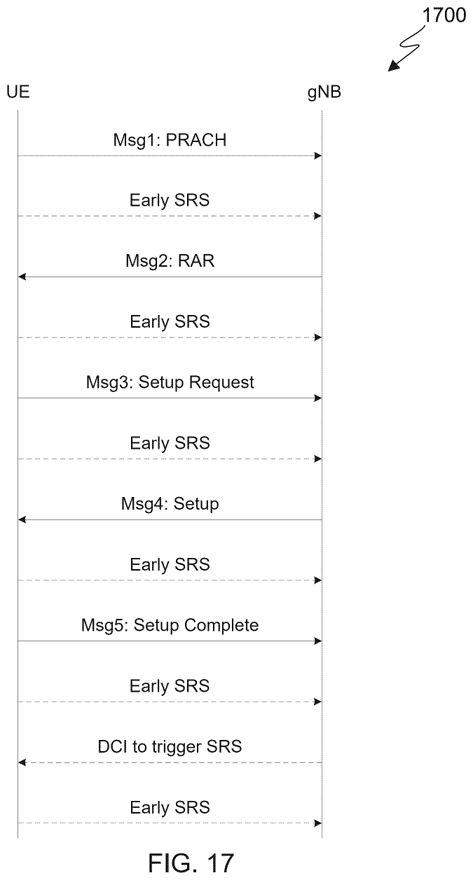

FIG. 17 illustrates an example procedure 1700 for early SRS triggering for an inactive mode according to embodiments of the present disclosure. The procedure 1700 of FIG. 17 can be performed by any of the UEs 111-116 of FIG. 1, such as the UE 116 of FIG. 3, and any of the BSs 101-103 of FIG. 1, such as BS 102 of FIG. 2. The procedure 1700 is for illustration only and other embodiments can be used without departing from the scope of the present disclosure.

For inactive mode, as illustrated in FIG. 17, UEs the following is a summary of the aforementioned options. The dotted lines in FIG. 17 illustrated possible options for transmitting SRS or for triggering SRS by DCI.

| | |
|---|---|
| Early SRS capability | Provided by: |
| | Msg1 (PRACH): Alt1 |
| | Msg3 (e.g., Connection Setup Request): Alt2 |
| | Msg5 (e.g., Connection Setup Complete): Alt3 |
| | Determined implicitly by network based on DTX detection of SRS: |
| | Alt4 |
| SRS Antenna | Provided by: |
| switching capability | Msg1 (PRACH) |
| or configuration | Msg3 (e.g., Resume Request) |
| | Msg5 (e.g., Resume Complete) |
| Early SRS resource | Provided by: |
| and/or resources set | Stored in UE context. |
| configuration | SIBx configuration. e.g., based on configuration of SRS resources |
| | and/or SRS resource sets, or based on association between preamble |
| | and/or RO and SRS resources and/or SRS resource sets. |
| | Msg4 (Resume) |
| Trigger for SRS | Provided by: |
| | Msg2 (RAR): Alt1a (implicit . . . no flag), Alt1b (explicit . . . flag) |
| | Msg4 (Resume): Alt1c/Alt2a (implicit . . . no flag), Alt1d/Alt2b |
| | (explicit . . . flag) |
| | PDCCH trigger after Msg5 (Resume complete): Alt1e/Alt2c/Alt3c |
| Resource used for | Determined based on: |
| early SRS | Default antenna switching capability if SRS antenna switching |
| | capability is unknown |
| | SRS antenna switching capability |

| | Alt1 | Alt2 | Alt3 | Alt4 |
|---|---|---|---|---|
| UE context | | Opt0: Configure | Opt0: Configure | |
| | | Early SRS | Early SRS | |
| | | resources | resources | |
| SIBx | Preamble/RO | Opt1: Configure | Opt1: Configure | Opt1: Configure |
| | config: 2 groups | early SRS | early SRS | early SRS |
| | early SRS support | resources | resources | resources |
| | Optional N | | | |
| | groups for SRS | | | |
| | antenna switching | | | |
| | capability | | | |
| | indication. | | | |
| | Configure early | | | |
| | SRS resources | | | |
| Msg1 (Preamble) | Group 0: No early | | | |
| | SRS | | | |
| | Group 1: Early | | | |
| | SRS | | | |
| | Other groups to | | | |
| | optionally | | | |
| | indicate SRS | | | |
| | antenna switching | | | |
| | capability | | | |
| Msg2 (RAR) | Alt1a: Implicit | | Alt3a: Trigger for | Alt4a: Flag to |
| | trigger of early | | early SRS. | trigger early SRS |
| | SRS based on | | Early SRS sent | If UE doesn't |
| | preamble/RO | | after Msg5 | support early |
| | group | | | SRS, flag is |
| | Alt1b: Flag to | | | ignored and there |
| | trigger early SRS | | | is no early SRS is |
| | If SRS antenna | | | transmitted. |
| | switching | | | |
| | capability is | | | |
| | unknown use | | | |
| | default resources. | | | |
| Msg3 (Resume | Resume request | Resume request | | |
| request) | provides pointer | provides pointer | | |
| | to stored context, | to stored context, | | |
| | network can | network can | | |
| | determine early | determine early | | |
| | SRS capability | SRS capability | | |
| | and SRS antenna | and SRS antenna | | |
| | switching | switching | | |
| | capability | capability | | |
| Msg4 (Resume) | Alt1c: Implicit | Opt2: Msg4 can | Opt2: Msg4 can | Opt2: Msg4 can |
| | trigger of early | provide SRS | provide SRS | provide SRS |
| | SRS based on | resources | resources | resources |
| | preamble/RO | Alt2a: Implicit | Alt3b: Trigger for | Alt4b: Flag to |
| | group. | trigger of early | early SRS. | trigger early SRS |
| | Alt1d: Flag to | SRS based | Early SRS sent | |
| | trigger early SRS | whether or not UE | after Msg5 | |
| | SRS antenna | supports early | | |
| | switching | SRS. | | |
| | capability can be | Alt2b: Flag to | | |
| | used based on | trigger early SRS | | |
| | signaling in Msg3 | SRS antenna | | |
| | | switching | | |
| | | capability can be | | |
| | | used based on | | |
| | | signaling in Msg3 | | |
| Msg5 (Resume | Alt1e: PDDCH | Alt2c: PDDCH | Msg5 can indicate | |
| complete) | after Msg5 can | after Msg5 can | support for early | |
| | trigger early SRS | trigger early SRS | SRS and | |
| | transmission | transmission | optionally SRS | |
| | based on early | based on early | antenna switching | |
| | SRS capability | SRS capability | capability. | |
| | and optionally | and optionally | Alt3c: PDDCH | |
| | based on SRS | based on SRS | after Msg5 can | |
| | antenna switching | antenna switching | trigger early SRS | |
| | capability | capability | transmission | |
| | | | based on early | |
| | | | SRS capability | |
| | | | and optionally | |
| | | | based on SRS | |
| | | | antenna switching | |
| | | | capability | |

Various embodiments of the present disclosure provide for SRS transmission associated with random access procedure transmissions. In one example, the SRS is transmitted associated with PRACH preamble. In one example, a UE can be configured by system information to transmit SRS associated with or after a PRACH preamble. In one example, a UE can be indicated by a PEI and/or a paging message to transmit SRS associated with or after a PRACH preamble as aforementioned. The SRS transmission can be further conditioned on whether the UE transmits an associated PRACH preamble/RO from a first group of preambles and/or ROs or from a second group of preambles and/or ROs indicated in the system information. The SRS transmission can be further conditioned on whether the UE transmits an associated PRACH preamble/RO from a group of preambles and/or ROs from N groups of preambles and/or ROs indicated in the system information.

In one example, the SRS resource can be transmitted at or after a time T after the end (or start) of the PRACH transmission associated with the UE transmitting SRS. In one example, the slot or subframe or frame used to transmit SRS resource can be at or after a time T from the end (or start) or time-unit (e.g. slot) of the PRACH transmission associated with the UE transmitting SRS. In one example, the slot or subframe or frame used to transmit SRS resource is that first slot or subframe or frame that starts at or after a time T from the end (or start) or time-unit (e.g., slot) of the PRACH transmission associated with the UE transmitting SRS. Wherein, the time T can be defined in the system specifications and/or configured or updated by network (e.g., using SIB signaling and/or RRC signaling and/or MAC CE signaling and/or L1 control signaling). In one example, a PRACH occasion is mapped to a SRS occasion where the UE can transmit SRS. In one example, a one or more PRACH occasions are mapped to a SRS occasion where the UE can transmit SRS. In one example, a PRACH occasion is mapped to one or more SRS occasions where the UE can transmit SRS, for example, one or more preambles of a PRACH occasion are mapped to a SRS occasion.

In one example, the transmission of SRS associated with PRACH is as illustrated in FIG. 15A (the SRS instances can be one-shot, N-shots or semi-persistent), where SRS trigger can be replaced by PRACH transmission.

In one example, the SRS is associated with a RACH scheduled transmission or a Msg3. In one example, a UE can be configured by system information to transmit SRS associated with or after a Msg3. In one example, a UE can be indicated by a PEI and/or a paging message to transmit SRS associated with or after a Msg3 as aforementioned. In one example, a UE can be indicated by a RAR to transmit SRS associated with or after a Msg3 as aforementioned. The SRS transmission can be further conditioned on whether the UE transmits an associated PRACH preamble/RO from a first group of preambles and/or ROs or from a second group of preambles and/or ROs indicated in the system information. The SRS transmission can be further conditioned on whether the UE transmits an associated PRACH preamble/RO from a group of preambles and/or ROs from N groups of preambles and/or ROs indicated in the system information. In one example, a UE can indicate in the Msg3 (e.g., by flag) whether or not there is an SRS transmission associated with Msg3. In one example, Msg3 indicates antenna switching capability (xTyR), or not being able to support antenna switching (e.g., for early SRS).

In one example, the SRS resource can be transmitted at or after a time T after the end (or start) of the PUSCH transmission providing Msg3 associated with the UE transmitting SRS. In one example, the slot or subframe or frame used to transmit SRS resource can be at or after a time T after the end (or start) or time-unit (e.g., slot) of the Msg3 PUSCH transmission associated with the UE transmitting SRS. In one example, the slot or subframe or frame used to transmit SRS resource is that first slot or subframe or frame that starts at or after a time T after the end (or start) or time-unit (e.g., slot) of the Msg3 PUSCH transmission associated with the UE transmitting SRS. Wherein, the time T can be defined in the system specifications and/or configured or updated by network (e.g., using SIB signaling and/or RRC signaling and/or MAC CE signaling and/or L1 control signaling).

In one example, the transmission of SRS associated with Msg3 is as illustrated in FIG. 15A (the SRS instances can be one-shot, N-shots or semi-persistent), where SRS trigger can be replaced by PUSCH transmission providing Msg3.

In one example, the SRS is associated with a MsgA of Type-2 random access procedure. In one example, a UE can be configured by system information to transmit SRS associated with or after a MsgA. In one example, a UE can be indicated by a PEI and/or a paging message to transmit SRS associated with or after a MsgA as aforementioned. The SRS transmission can be further conditioned on whether the UE transmits an associated msgA PRACH preamble/RO from a first group of preambles and/or ROs or from a second group of preambles and/or ROs indicated in the system information. The SRS transmission can be further conditioned on whether the UE transmits an associated MsgA PRACH preamble/RO from a group of preambles and/or ROs from N groups of preambles and/or ROs indicated in the system information. In one example, a UE can indicate in the MsgA PUSCH (e.g., by flag) whether or not there is an SRS transmission associated with MsgA. In one example, MsgA PUSCH indicates antenna switching capability (xTyR), or not being able to support antenna switching (e.g., for early SRS).

In one example, the SRS resource can be transmitted at or after a time T from the end (or start) of the MsgA (MsgA PRACH or MsgA PUSCH) transmission associated with the UE transmitting SRS. In one example, the slot or subframe or frame used to transmit SRS resource can be at or after a time T from the end (or start) or time-unit (e.g., slot) of the MsgA (e.g., MsgA PRACH or MsgA PUSCH) transmission associated with the UE transmitting SRS. In one example, the slot or subframe or frame used to transmit SRS resource is that first slot or subframe or frame that starts at or after a time T from the end (or start) or time-unit (e.g., slot) of the MsgA (e.g., MsgA PRACH or MsgA PUSCH) transmission associated with the UE transmitting SRS. Wherein, the time T can be defined in the system specifications and/or configured or updated by network (e.g., using SIB signaling and/or RRC signaling and/or MAC CE signaling and/or L1 control signaling). In one example, a PRACH occasion is mapped to a SRS occasion where the UE can transmit SRS. In one example, a one or more PRACH occasions are mapped to a SRS occasion where the UE can transmit SRS. In one example, a PRACH occasion is mapped to one or more SRS occasions where the UE can transmit SRS, for example, one or more preambles of a PRACH occasion are mapped to a SRS occasion.

In one example, the transmission of SRS associated with MsgA is as illustrated in FIG. 15A (the SRS instances can be one-shot, N-shots or semi-persistent), where SRS trigger can be replaced by MsgA PRACH transmission.

In one example, the transmission of SRS associated with MsgA is as illustrated in FIG. 15A (the SRS instances can be one-shot, N-shots or semi-persistent), where SRS trigger can be replaced by MsgA PUSCH transmission.

In the aforementioned examples, early SRS triggering, can be replaced by early CSI-RS measurement and/or early CSI reporting, wherein the trigger can be for early measuring of CSI-RS (or SSB) using configured resources (e.g., in SIB1 or in Msg4 or in MsgB) and/or early reporting of CSI on uplink resources (e.g., PUCCH or PUSCH) wherein the UL resources and report configuration are configured by SIB1 or in Msg4 or in MsgB.

FIG. 18 illustrates an example method 1800 performed by a UE in a wireless communication system according to embodiments of the present disclosure. The method 1800 of FIG. 18 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1800 is for illustration only and other embodiments can be used without departing from the scope of the present disclosure.

The method 1800 begins with the UE receiving a SIB (1810). For example, in 1810, the SIB includes N groups of SRS resource sets for antenna switching and the N groups of SRS resource sets correspond to N antenna switching capabilities, respectively. The UE then initiates a Type-1 RA procedure to transition from an idle state to a connected state (1820). The UE then transmits, in msg3 of the RA procedure, information indicating an antenna switching capability from the N antenna switching capabilities supported by the UE (1830). In various embodiments, the LCID/eLCID included in the msg 3 indicates the antenna switching capability supported by the UE.

The UE then receives, in msg4 of the RA procedure, signaling that triggers transmission of an SRS resource set from the N groups of SRS resource sets (1840). The SRS resource set corresponds to the antenna switching capability. In various embodiments, the msg4 is scheduled by DCI and the msg4 includes a flag indicating triggers for transmission of the SRS resource set. In various embodiments, the antenna switching capability corresponds to xTyR, x is a number of transmit antenna ports, and y is a number of receive antenna ports. In various embodiments, the SRS resource set includes y/x SRS resources and an SRS resource from the SRS resource set includes x antenna ports. In various embodiments, a number of resource sets in a group, of the N groups of SRS resource sets, associated with the antenna switching capability is M and the msg4 includes a field of size ┌log₂ M┐ that indicates an identity of the SRS resource set. The UE then transmits SRS resources from the SRS resource set (1850). In various embodiments, the SRS resource set is an aperiodic SRS resource set.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive a system information block (SIB), wherein the SIB includes N groups of sounding reference signal (SRS) resource sets for antenna switching and wherein the N groups of SRS resource sets correspond to N antenna switching capabilities, respectively; and
a processor operably coupled to the transceiver, the processor configured to initiate a Type-1 random access (RA) procedure to transition from an idle state to a connected state,
wherein the transceiver is further configured to:
transmit, in a message 3 (msg3) of the RA procedure, information indicating an antenna switching capability from the N antenna switching capabilities supported by the UE,
receive, in a message 4 (msg4) of the RA procedure, signaling that triggers transmission of an SRS resource set from the N groups of SRS resource sets, wherein the SRS resource set corresponds to the antenna switching capability, and
transmit SRS resources from the SRS resource set.

2. The UE of claim 1, wherein:
the antenna switching capability corresponds to xTransmityReceive (xTyR),
x is a number of transmit antenna ports, and
y is a number of receive antenna ports.

3. The UE of claim 2, wherein:
the SRS resource set includes y/x SRS resources, and
an SRS resource from the SRS resource set includes x antenna ports.

4. The UE of claim 1, wherein the SRS resource set is an aperiodic SRS resource set.

5. The UE of claim 1, wherein
a number of resource sets in a group, of the N groups of SRS resource sets, associated with the antenna switching capability is M, and
the msg4 includes a field of size ┌log² M┐ that indicates an identity of the SRS resource set.

6. The UE of claim 1, wherein a logical channel identifier (LCID)/extended LCID (eLCID) included in the msg3 indicates the antenna switching capability supported by the UE.

7. The UE of claim 1, wherein:
the msg4 is scheduled by downlink control information (DCI), and
the msg4 includes a flag indicating triggers for transmission of the SRS resource set.

8. A base station (BS) comprising:
a processor; and
a transceiver operably coupled to the processor, the transceiver configured to:
transmit a system information block (SIB), wherein the SIB includes N groups of sounding reference signal (SRS) resource sets for antenna switching and wherein the N groups of SRS resource sets correspond to N antenna switching capabilities, respectively,
receive a physical random access channel (PRACH) preamble from a UE for a Type-1 random access (RA) procedure to transition from an idle state to a connected state,
receive, in a message 3 (msg3) of the RA procedure, information indicating an antenna switching capability from the N antenna switching capabilities supported by the UE,
transmit, in a message 4 (msg4) of the RA procedure, signaling that triggers transmission, from the UE, of an SRS resource set from the N groups of SRS resource sets, wherein the SRS resource set corresponds to the antenna switching capability, and
receive SRS resources from the SRS resource set.

9. The BS of claim 8, wherein:
the antenna switching capability corresponds to xTransmityReceive (xTyR),
x is a number of transmit antenna ports at the UE, and
y is a number of receive antenna ports at the UE.

10. The BS of claim 9, wherein:
the SRS resource set includes y/x SRS resources, and
an SRS resource from the SRS resource set includes x antenna ports.

11. The BS of claim 8, wherein, the SRS resource set is an aperiodic SRS resource set.

12. The BS of claim 8, wherein
a number of resource sets in a group, of the N groups of SRS resource sets, associated with the antenna switching capability is M, and
the msg4 includes a field of size ┌log₂ M┐ that indicates an identity of the SRS resource set.

13. The BS of claim 8, wherein a logical channel identifier (LCID)/extended LCID (eLCID) included in the msg3 indicates the antenna switching capability supported by the UE.

14. The UE of claim 8, wherein:
the msg4 is scheduled by downlink control information (DCI), and
the msg4 includes a flag indicating triggers for transmission of the SRS resource set.

15. A method of operating a user equipment (UE), the method comprising:
receiving a system information block (SIB), wherein the SIB includes N groups of sounding reference signal (SRS) resource sets for antenna switching and wherein the N groups of SRS resource sets correspond to N antenna switching capabilities, respectively;
initiating a Type-1 random access (RA) procedure to transition from an idle state to a connected state;
transmitting, in a message 3 (msg3) of the RA procedure, information indicating an antenna switching capability from the N antenna switching capabilities supported by the UE;
receiving, in a message 4 (msg4) of the RA procedure, signaling that triggers transmission of an SRS resource set from the N groups of SRS resource sets, wherein the SRS resource set corresponds to the antenna switching capability; and
transmitting SRS resources from the SRS resource set.

16. The method of claim 15, wherein:
the antenna switching capability corresponds to xTransmityReceive (xTyR),
x is a number of transmit antenna ports,
y is a number of receive antenna ports,
the SRS resource set includes y/x SRS resources, and
an SRS resource from the SRS resource set includes x antenna ports.

17. The method of claim 15, wherein the SRS resource set is an aperiodic SRS resource set.

18. The method of claim 15, wherein
a number of resource sets in a group, of the N groups of SRS resource sets, associated with the antenna switching capability is M, and
the msg4 includes a field of size ┌log₂ M┐ that indicates an identity of the SRS resource set.

19. The method of claim 15, wherein a logical channel identifier (LCID)/extended LCID (eLCID) included in the msg3 indicates the antenna switching capability supported by the UE.

20. The method of claim 15, wherein:
the msg4 is scheduled by downlink control information (DCI), and
the msg4 includes a flag indicating triggers for transmission of the SRS resource set.
